(19) United States
(12) Patent Application Publication
(10) Pub. No.: US 2011/0164322 A1
(43) Pub. Date: Jul. 7, 2011

(54) ANTIREFLECTIVE FILM, METHOD OF PRODUCTION THEREOF, AND UV-CURABLE RESIN MATERIAL COMPOSITION COATING LIQUID

(75) Inventors: Takeshi Morozumi, Miyagi (JP); Tomoo Fukuda, Miyagi (JP); Kentaroh Ishikawa, Tochigi (JP); Yuichi Sasaki, Miyagi (JP); Sung-kil Lee, Miyagi (JP)

(73) Assignee: SONY CORPORATION, Tokyo (JP)

(21) Appl. No.: 12/962,282

(22) Filed: Dec. 7, 2010

(30) Foreign Application Priority Data
Dec. 8, 2009 (JP) P2009-278484

(51) Int. Cl. G02B 1/11; C09D 133/00; C08F 2/44; C08K 9/06; B05D 5/06; B05D 3/02; B05D 3/06; B05D 1/36; B05D 1/34; B05D 3/00

(52) U.S. Cl. 359/601; 524/853; 427/521

(57) ABSTRACT

A UV-curable resin material composition coating liquid is provided and includes a UV-curable resin material composition dissolved or dispersed in a nonpolar solvent or a substantially nonpolar mixed solvent. The UV-curable resin material composition includes a monomer and/or an oligomer thereof that have two or more (meth)acryloyl groups, and affinity to a nonpolar solvent, modified hollow silica fine particles altered to have affinity to a nonpolar solvent by introduction of an aliphatic hydrocarbon group to surfaces of hollow silica fine particles, and a polymerization initiator.

### CROSS REFERENCES TO RELATED APPLICATIONS

The present application claims priority to Japanese Patent Application JP 2009-278484 filed on Dec. 8, 2009, the entire contents of which is hereby incorporated by reference.

### BACKGROUND

The present disclosure relates to antireflective films that have a low-refractive-index layer on the outermost surface, methods of production thereof, and UV-curable resin material composition coating liquids preferable as material of the low-refractive-index layer.

There has been wide-spread use of image display devices including liquid crystal display devices (LCD), plasma display devices (PDP), electroluminescence display devices (ELD), and cathode ray tube display devices (CRT). Many of these image display devices are provided with an antireflective layer, formed on the user-side outermost surface of the image display section to prevent non-data display light from being reflected on the display screen and entering the eyes of the user. The antireflective layer has the effect of preventing reflection of outside light and making the screen more viewable, and improving display quality with improved contrast.

The common method of providing the antireflective layer on the display screen is to attach an antireflective layer-containing antireflective film on a surface of a transparent base film. The antireflective film is available in different forms, including those having a low-refractive-index layer formed on a transparent base film and that has a lower refractive index than the transparent base film, and those having a high-refractive-index layer and a low-refractive-index layer formed on a transparent base film, the former having a higher refractive index than the transparent base film, and the latter having a lower refractive index than the transparent base film.

Because of desirable properties including mechanical properties, transparency, heat resistance, materials such as a polyethylene terephthalate (PET) film, a triacetyl cellulose (TAC) film, and a cycloolefin polymer (COP) film are used as the base film. Organic resin material compositions that readily allow for formation of a resin material layer using a method such as coating are preferable as the material of the antireflective layer. Use of heat-curable resin as the resin material requires heat for the curing of the resin material layer. However, because the heat can deform the base material, it is undesirable when the base material is a thin film. For this reason, UV-curable resin that can be cured without heat is generally used as the resin for the antireflective layer.

The low-refractive-index layer in the antireflective layer should have as small a refractive index as possible, because reflectance becomes smaller as the refractive index of the low-refractive-index layer becomes lower, or as the refractive index of the high-refractive-index layer becomes higher. In an effort to reduce the refractive index of the low-refractive-index layer, a resin composition is proposed in which fine particles having a lower refractive index than the binder resin of the low-refractive-index layer are dispersed in the binder resin. The advantage of this approach is that the refractive index of the low-refractive-index layer can easily be varied by varying the amount of fine particles added. However, it is generally difficult to uniformly disperse the fine particles in the binder resin, and some other mean is required to obtain a low-refractive-index layer that excels in transparency and antireflection performance.

For example, JP-A-8-244178 (claim 1, pp. 2-5, and 10; Patent Document 1) proposes a ultrafine particle-containing antireflective film in which at least one of the layers formed on a transparent base film either directly or via some other layer is a resin layer of controlled refractive index formed from a ultrafine particle-containing resin composition, and in which the layer formed on the outermost surface has a lower refractive index than the lower layer directly in contact therewith. The resin composition contains carboxyl group-containing (meth)acrylate as part of or all of the binder resin component. The (meth)acrylate means acrylate or methacrylate.

According to Patent Document 1, the carboxyl group-containing (meth)acrylate can desirably disperse the ultrafine particles. Further, presumably because of the carboxyl group, the resin composition has good adhesion to various kinds of plastic base materials, and can thus form a binder resin that excels in abrasion resistance. When a carboxyl group-containing (meth)acrylate having a plurality of acryloyl groups is used, there will be no decrease in acryloyl group density even upon mixing with a multifunctional acrylate that has a hydroxy group and three or more acryloyl groups. The resulting ultrafine particle-containing antireflective film therefore excels in transparency, and has a small haze value and a low reflectance. The film also excels in hardness, such as pencil hardness and abrasion resistance, and interlayer adhesion. A solvent is appropriately used, for example, for the purpose of adjusting the viscosity of the resin material composition. For example, aromatic hydrocarbons, esters, alcohols, ketones, ethers, ether esters, and mixtures thereof can be used as the solvent. In an example that uses silica fine particles as the ultrafine particles, a mixed solvent of ethanol and toluene is used.

JP-A-2005-99778 (claims 1, 3, 10, pp. 6-8, 10, 14, and 15, FIG. 1; Patent Document 2) proposes an antireflective laminate that includes at least a low-refractive-index layer having a refractive index of 1.45 or less on a light-transmissive base material. The low-refractive-index layer includes an ionization radiation-curable resin composition, and porous or hollow silica fine particles having a shell layer. At least a part of the surface of some of or all of the silica fine particles are treated with a silane coupling agent that has an ionization radiation-curable group.

As described in this publication, the ionization radiation-curable group is preferably an acryloyl group and/or a methacryloyl group, and the antireflective laminate is preferably formed by the covalent bond formed by the chemical reaction between the ionization radiation-curable resin composition and the ionization radiation-curable group of the silane coupling agent introduced to the surfaces of the silica fine particles, directly and/or via the ionization radiation-curable group of a free silane coupling agent.

The following is an excerpt from Patent Document 2.

The porous or hollow silica fine particles have a low refractive index owning to the air-filled voids. The refractive index of the coating film can thus be effectively reduced by adding the silica fine particles. Further, the ionization radiation-curable group-containing silane coupling agent introduced to at least a part of the silica fine particle surfaces improves affinity to the binder component, and thus enables the silica fine particles to be uniformly dispersed in the coating liquid or the coating film. Further, in the process of curing the coating film, the ionization radiation-curable group of the silane coupling agent polymerizes with the ionization radiation-curable group of the binder component, directly and/or via the ionization radiation-curable group of a free silane coupling agent, and integrates the film by a covalent bond. There accordingly will be no large decrease in the hardness and strength of the cured film even when the amount of silica fine particles is considerably large with respect to the resin composition. As a result, a low-refractive-index layer of low refractive index having superior mechanical strength can be realized.

The solvent used to dissolve or disperse the solid component of the low-refractive-index layer is not particularly limited, and various organic solvents, for example, such as alcohols, ketones, esters, halogenated hydrocarbons, aromatic hydrocarbons, and mixtures thereof can be used. Use of ketone solvents is preferable for the preparation of the coating liquid, because it enables the coating liquid to be easily and uniformly coated over a base material surface in a thin layer. Further, because the solvent evaporates at an appropriate speed and dries more or less evenly after the coating step, a large-area coating film of a uniform thickness can easily be obtained.

JP-A-2005-283611 (claim 1, pp. 3-7; Patent Document 3) proposes an antireflective film that includes a low-refractive-index layer. The low-refractive-index layer has a surface arithmetic average roughness Ra of 1 nm or more and less than 2 nm, and is formed on at least one side of a light-transmissive base film either directly or via some other layer. The antireflective film as the laminate has a haze of 0.4 or less. The low-refractive-index layer includes hollow silica fine particles or porous silica fine particles, and the resin composition that forms the low-refractive-index layer contains an organic solvent with the hydrophilic organic solvent content of 50% or higher, a binder resin, and hollow silica fine particles or porous silica fine particles.

The following is an excerpt from Patent Document 3.

The transparency of the low-refractive-index layer improves with the use of the coating composition that contains an organic solvent whose hydrophilic organic solvent content is 50% or higher. This is probably because the organic solvent has good affinity to the hydroxy group present on the surfaces of the porous silica fine particles or hollow silica fine particles, and thus improves the dispersibility of the porous silica fine particles or hollow silica fine particles, making it difficult for the porous silica fine particles or hollow silica fine particles to form irregularities on the surface of the coating film.

The hydrophilic organic solvent may be methanol, ethanol, 2-propanol, or 1-butanol, of which 1-butanol is particularly preferable. With 1-butanol, the drying time of the coating film becomes longer than when other hydrophilic organic solvents are used, and accordingly the coating film forms at a slower rate. By the leveling effect, the porous silica fine particles or hollow silica fine particles are more uniformly dispersed in the coating film, and a smooth coating film surface is created. Examples of the organic solvent other than the hydrophilic organic solvent, and that may be contained in a content of less than 50% include ketones, esters, ethers, glycols, glycol ethers, aliphatic hydrocarbons, halogenated hydrocarbons, aromatic hydrocarbons, N-methylpyrrolidone, and dimethylformamide.

In forming different layers such as the high-refractive-index layer and the low-refractive-index layer, coating and curing are commonly performed for each layer. This is problematic because it has poor productivity and thus may lead to increased cost. Other problems include the tendency to lower interlayer adhesion and abrasion resistance.

In the light of these drawbacks, JP-A-2007-293302 (claims 1-4, pp. 5-10, 17, 18, 28-31, FIG. 1; Patent Document 4) proposes an optical film producing method that includes the steps of: simultaneously coating a transparent base with at least two coating layers using at least two kinds of coating liquids that contain a solvent and a solute; and drying the solvents in these at least two coating layers to simultaneously form at least two optical layers (for example, a low-refractive-index layer and a high-refractive-index layer).

The following is an excerpt from Patent Document 4.

In the optical film producing method, the simultaneous coating and drying of the coating liquids involve no intermixing of the solute components between the layers, and formation of a layer interface thin enough to produce optical interference. Such a layer structure cannot always be realized simply by layering coating liquids that are insoluble to each other, for example, such as an organic solvent-based solution and an aqueous solution. The foregoing layer structure requires satisfying any one of the following conditions between the simultaneously coated adjacent layers.

In a first aspect, it is preferable that the solute in the layer (lower layer) disposed on the base side and the layer (upper layer) disposed on the surface side be related in such a manner that the lower layer solute is insoluble or poorly soluble to the upper layer solvent across the plane separating the adjacent layers. Preferably, the upper layer solute and the lower layer solvent have the same relation at the plane separating these layers. However, in this case, the upper layer becomes nonuniform, and an island layer is formed. This is believed to be due to the lack of affinity between the upper layer solute and the lower layer solvent being evaporated through the upper layer, causing the upper layer solute to agglomerate, and changing the shape of the interface from layered to spherical. If the solute in each layer were insoluble to the solvent of the other layer, the solute of each layer undergoes phase separation and deposits at the layer interface, and a uniform layer interface is no longer formed. Thus, in a further preferred aspect, the upper layer solute is preferably readily soluble in the lower layer solvent.

In a second aspect, it is preferable to use such coating liquid compositions that the components of the upper layer and the lower layer quickly undergo phase separation even after being mixed. In this case, the components of the two layers immediately undergo phase separation in the vicinity of the layer interface as these components diffuse upon application, and further diffusion is suppressed. Further, the micro liquid droplets after the phase separation have the high probability of merging into the original layer, and a uniform liquid-liquid interface can be maintained. In a third aspect, the relation of the second aspect is satisfied when the evaporation of the solvent proceeds to a certain extent. In this case, mixing may occur immediately after application; however, this is quickly followed by phase separation, and a practically desirable interface can be formed.

### SUMMARY

When the low-refractive-index layer-forming resin material composition contains surface-untreated silica fine particles as in Patent Documents 1 and 3, it is preferable to use hydrophilic solvents, including alcohols such as ethanol and 1-bitanol, or mixed solvents of alcohols and other solvents, as the solvent added to adjust the viscosity of the resin material composition. Hydrophilic solvents are preferable because they have good affinity to the hydroxyl group present on the surfaces of the silica fine particles.

When the surfaces of the silica fine particles contained in the resin material composition are altered by treatment with, for example, a silane coupling agent as in Patent Document 2, the properties of the silica fine particle surface are strongly influenced by the properties of the group introduced by the surface treatment. When the group introduced by the silane coupling agent is an acryloyl group and/or a methacryloyl group as in Patent Document 2, slightly polar solvents, for example, such as ketones, esters, alcohols, ethers, and halogenated hydrocarbons, may preferably used as the solvent added to, for example, adjust the viscosity of the resin material composition, because the acryloyl group and/or methacryloyl group have some polarity.

As described above, polar solvents with varying degrees of polarity have been used as the solvent for the coating liquid that includes the low-refractive-index layer-forming silica fine particle-containing resin material composition dissolved or dispersed in the solvent. However, when the base film is a film with no affinity to polar solvents, such coating liquids using polar solvents cannot be used to form the low-refractive-index layer on the film with good adhesion.

Coating liquids using polar solvents may have limited use. For example, when a high-refractive-index layer and a low-refractive-index layer formed thereon both contain a (meth)acrylic resin monomer as the primary solute, a solvent of similar polarity, for example, ketone is often used to prepare the coating liquids for these layers. In this case, because the two kinds of coating liquids for these two layers easily mix together, these coating liquids cannot be applied simultaneously. Thus, in order to allow the simultaneous application of the two coating layers as in the optical film producing method proposed in Patent Document 4, it is required to use an appropriate solvent for each type of coating liquid so that intermixing of the two coating liquids is suppressed.

Accordingly, there is a need for an antireflective film provided with a low-refractive-index layer on the outermost surface, a method of production thereof, and a UV-curable resin material composition coating liquid that allows the low-refractive-index layer to be formed in contact with a base film that has no affinity to polar solvents, and thus can be used in many different ways.

According to an embodiment, there is provided a UV-curable resin material composition coating liquid that includes a UV-curable resin material composition dissolved or dispersed in a nonpolar solvent or a substantially nonpolar mixed solvent, the UV-curable resin material composition including: a monomer and/or an oligomer thereof that have two or more (meth)acryloyl groups, and affinity to a nonpolar solvent; modified hollow silica fine particles altered to have affinity to a nonpolar solvent by introduction of an aliphatic hydrocarbon group to surfaces of hollow silica fine particles; and a polymerization initiator.

As used herein, the “(meth)acryloyl group” means an acryloyl group or a methacryloyl group. The “substantially nonpolar mixed solvent” means a mixed solvent that is essentially a nonpolar solvent in the context in terms of solvent properties, even if it contains a very small fraction of a solvent other than a nonpolar solvent for reasons relating to, for example, production steps. To avoid confusion, the composition containing a monomer and/or an oligomer before curing will be called a resin material composition, and the polymer after curing will called a resin composition.

According to another embodiment, there is provided an antireflective film that includes a low-refractive-index layer provided on an outermost surface of a base film either directly on the base film or via a functional layer, the low-refractive-index layer being formed using the UV-curable resin material composition coating liquid, and being a cured layer of a resin material composition layer that includes: the monomer and/or the oligomer thereof that have two or more (meth)acryloyl groups, and affinity to a nonpolar solvent; the modified hollow silica fine particles altered to have affinity to a nonpolar solvent by introduction of an aliphatic hydrocarbon group to surfaces of hollow silica fine particles; and the polymerization initiator.

According to another embodiment, there is provided a method for producing an antireflective film. The method includes: preparing a low-refractive-index layer coating liquid that contains a UV-curable resin material composition that forms a low-refractive-index layer having a lower refractive index than a base film, the low-refractive-index layer coating liquid being prepared by dissolving or dispersing in a nonpolar solvent or a substantially nonpolar mixed solvent a UV-curable resin material composition that includes: a monomer and/or an oligomer thereof that have two or more (meth)acryloyl groups, and affinity to a nonpolar solvent; modified hollow silica fine particles altered to have affinity to a non-polar solvent by introduction of an aliphatic hydrocarbon group on surfaces of hollow silica fine particles; and a polymerization initiator; layering the low-refractive-index layer coating liquid on the base film either directly or via a functional layer; evaporating the nonpolar solvent or the substantially nonpolar mixed solvent from the layer of the low-refractive-index layer coating liquid; and curing the UV-curable resin material composition layer to form the low-refractive-index layer on an outermost surface of the base film.

According to the UV-curable resin material composition coating liquid of the embodiment, the nonpolar solvent or the substantially nonpolar mixed solvent, for example, an aliphatic hydrocarbon solvent or alicylic hydrocarbon is used for the preparation of the coating liquid. With the use of the coating liquid, the UV-curable resin material composition coating layer can be formed in contact with the base film that has no affinity to polar solvents. Further, even in the presence of a lower layer that contains a material such as an uncured (meth)acrylic resin monomer, the UV-curable resin material composition coating layer still can be formed on such a lower layer without being seriously affected by the material of such a layer, or without seriously affecting such a layer material, provided that the material does not have affinity to the nonpolar solvent. The coating liquid can thus be used in many different ways, such as in simultaneous coating and time-lag coating with the lower layer. For these and other purposes, the coating liquid uses modified hollow silica fine particles altered to have affinity to nonpolar solvents by introduction of an aliphatic hydrocarbon group to the particle surface, and a monomer and/or an oligomer thereof that have two or more (meth)acryloyl groups, and affinity to nonpolar solvents. This ensures formation of the UV-curable resin material composition coating layer.

In the antireflective film of the embodiment, the low-refractive-index layer as a cured layer of the resin material composition layer formed from the UV-curable resin material composition coating liquid layer of the embodiment is formed on the outermost surface of the base film either directly on the base film or via a functional layer. Thus, the low-refractive-index layer can be formed in good adhesion in contact with the base film that has no affinity to polar solvents. Further, the low-refractive-index layer can be used in many different ways with the material of the functional layer laminated with the low-refractive-index layer.

The antireflective film producing method of the embodiment uses the UV-curable resin material composition coating liquid of the embodiment. It is therefore ensured that the antireflective film of the embodiment is formed in contact with the base film that has no affinity to polar solvents. Further, even in the presence of a lower layer that contains a material such as an uncured (meth)acrylic resin monomer, the UV-curable resin material composition coating layer still can be formed on such a lower layer without being seriously affected by the material of such a layer, or without seriously affecting such a layer material, provided that the material does not have affinity to the nonpolar solvent. The coating liquid can thus be used in many different ways.

The UV-curable resin material composition coating liquid of the embodiment can preferably be used to form the low-refractive-index layer on surfaces where application of the antireflective film is difficult, such as the surfaces of plastic molded products and coated objects.

Additional features and advantages are described herein, and will be apparent from the following Detailed Description and the figures.

### BRIEF DESCRIPTION OF THE FIGURES

FIG. 1A is a partial cross sectional view illustrating a structure of an antireflective film according to First Embodiment; FIGS. 1B and 1C are enlarged cross sectional views illustrating a surface structure of modified hollow silica fine particles.

FIG. 2 is an explanatory diagram representing the reaction steps of altering the surfaces of hollow silica fine particles using a silane coupling agent.

FIG. 3A is a partial cross sectional view illustrating a structure of an antireflective film according to Second Embodiment; FIG. 3B is a schematic diagram representing the gist of a time-lag coating method.

FIG. 4 is a transmission electron microscope (TEM) observed image of an ODTMS-modified hollow silica fine particle hexane sol obtained in Example 1.

FIG. 5 is a diagram representing infrared (IR) absorption spectra of powdery hollow silica fine particles obtained in Examples 1-1 to 1-3 and Comparative Examples 1-1 and 1-2.

FIG. 6 is a graph representing the particle size distribution of OTMS-modified hollow silica fine particles in a hexane sol obtained in Example 1-2.

FIG. 7 is a diagram representing IR absorption spectra of powdery modified hollow silica fine particles obtained in Examples 2-1 and 2-2 and Comparative Examples 2-1 and 2-2.

FIG. 8 is a graph representing the reflectance of an antireflective film obtained in Example 3-1.

FIG. 9A is a scanning electron microscope (SEM) observed image of a cross section of an antireflective film of a bilayer antireflective layer structure obtained in Example 4-1; FIG. 9B is a graph representing the result of elemental analysis at different positions A, B, and C along the depth direction.

FIG. 10A is an SEM observed image of a cross section of the antireflective film; FIG. 10B is a graph representing the reflectance of the antireflective film.

FIG. 11A is an SEM observed image of a cross section of an antireflective film of a bilayer antireflective layer structure obtained in Example 4-2;

FIG. 11B is a graph representing the result of elemental analysis at different positions A and B along the depth direction.

FIG. 12 is a graph representing the reflectance of the antireflective film of a bilayer antireflective layer structure.

FIGS. 13A to 13C are chromatograms representing the results of GC-MS analyses of hexane, air, and the antireflective film obtained in Example 4-2.

FIG. 14A is an SEM observed image of a cross section of an antireflective film of a bilayer antireflective layer structure obtained in Comparative Example 4-1; FIG. 14B is a graph representing the result of elemental analysis at different positions A and B along the depth direction.

FIGS. 15A and 15B are chromatograms representing the results of GC-MS analyses of the antireflective films obtained in Example 4-3 and Comparative Example 4-1.

FIG. 16A is a SEM observed image of a cross section of an antireflective film of a bilayer antireflective layer structure obtained in Comparative Example 4-2; FIG. 16B is a graph representing the result of elemental analysis at different positions A and B along the depth direction.

### DETAILED DESCRIPTION

In a UV-curable resin material composition coating liquid of an embodiment, the nonpolar solvent is preferably an aliphatic hydrocarbon solvent and/or an alicylic hydrocarbon solvent.

Preferably, the aliphatic hydrocarbon group has a C═C bond, and/or a polymerizable group polymerizable with the monomer and/or the oligomer thereof is introduced to the surfaces of the modified hollow silica fine particles in addition to the aliphatic hydrocarbon group.

In this case, the polymerizable group is preferably a (meth)acryloyl group or a vinyl group. The aliphatic hydrocarbon group and/or the polymerizable group are introduced as organic groups of a silane coupling agent residue to the surfaces of the hollow silica fine particles by a silane coupling reaction.

Preferably, the UV-curable resin material composition includes the monomer and/or the oligomer thereof in a content of 70 to 30 mass %, the modified hollow silica fine particles in a content of 30 to 70 mass %, and the polymerization initiator in a content of 0.1 to 10.0 mass %.

In an antireflective film of an embodiment, the low-refractive-index layer is preferably provided in direct contact with a surface of the base film that has no affinity to nonpolar solvents.

It is preferable that a high-refractive-index layer having a higher refractive index than the base film be provided as the functional layer, and that the low-refractive-index layer be provided in contact with the high-refractive-index layer. In this case, the high-refractive-index layer is preferably a cured layer of a resin material composition layer that contains: a monomer and/or an oligomer thereof that have two or more (meth)acryloyl groups, and affinity to polar solvents; and a polymerization initiator.

In an antireflective film producing method of an embodiment, it is preferable that a high-refractive-index layer having a higher refractive index than the base film be formed as the functional layer by at least:

preparing a high-refractive-index layer coating liquid that contains a UV-curable resin material composition that forms the high-refractive-index layer;

layering the high-refractive-index layer coating liquid on the base film; and

curing the resin material composition layer that forms the high-refractive-index layer, and

that the low-refractive-index layer is formed in contact with the high-refractive-index layer.

In this case, it is preferable to include:

forming the high-refractive-index layer coating liquid using a polar solvent;

simultaneously layering the high-refractive-index layer coating liquid and the low-refractive-index layer coating liquid on the base film;

evaporating the solvents from the high-refractive-index layer coating liquid layer and the low-refractive-index layer coating liquid layer; and

simultaneously curing the resin material composition layer that forms the high-refractive-index layer, and the resin material composition layer that forms the low-refractive-index layer.

Alternatively, it is preferable to include:

forming the high-refractive-index layer coating liquid without using a solvent;

simultaneously layering the high-refractive-index layer coating liquid and the low-refractive-index layer coating liquid on the base film;

evaporating the nonpolar solvent or the substantially nonpolar mixed solvent from the low-refractive-index layer coating liquid layer; and

simultaneously curing the resin material composition layer that forms the high-refractive-index layer, and the resin material composition layer that forms the low-refractive-index layer.

Further, it is preferable to include:

forming the high-refractive-index layer coating liquid using a polar solvent;

layering the high-refractive-index layer coating liquid on the base film;

layering the low-refractive-index layer coating liquid on the high-refractive-index layer coating layer after at least a part of the polar solvent is evaporated from the high-refractive-index layer coating layer during a time lag following the layering of the high-refractive-index layer coating layer;

evaporating the solvents from the high-refractive-index layer coating liquid layer and the low-refractive-index layer coating liquid layer; and

simultaneously curing the resin material composition layer that forms the high-refractive-index layer, and the resin material composition layer that forms the low-refractive-index layer.

The following specifically describes the UV-curable resin material composition and the antireflective film based on embodiments with reference to the accompanying drawings.

### First Embodiment

Examples of the UV-curable resin material composition coating liquids, the antireflective films and the antireflective film producing method according to First Embodiment will be described.

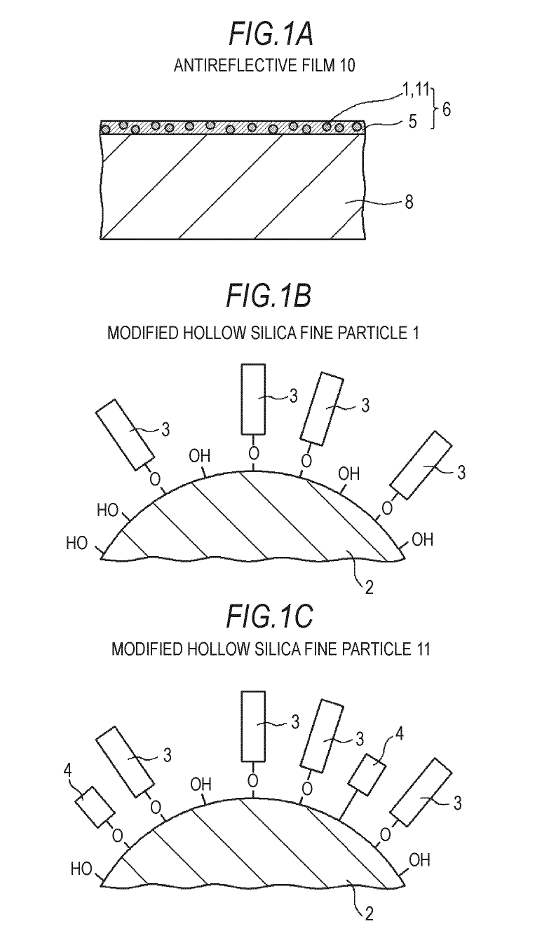

FIG. 1A is a partial cross sectional view illustrating a structure of an antireflective film 10 according to First Embodiment. The antireflective film 10 is configured to include a low-refractive-index layer 6 provided in direct contact with a transparent base film 8. The low-refractive-index layer 6 has a lower refractive index than the base film 8. The small refractive index of the low-refractive-index layer 6 is due to modified hollow silica fine particles 1 (or 11) uniformly dispersed in a (meth)acrylic resin composition 5. Despite the monolayer structure, the antireflective layer has sufficiently high antireflection performance because of the small refractive index of the low-refractive-index layer 6. Being simpler than multilayer films, the antireflective film 10 excels in productivity and cost performance.

For the fabrication of the antireflective film 10, a UV-curable resin material composition coating liquid is prepared by dissolving or dispersing a UV-curable resin material composition in a nonpolar solvent or a substantially nonpolar mixed solvent, the UV-curable resin material composition including: a monomer and/or an oligomer thereof that have two or more (meth)acryloyl groups, and affinity to a nonpolar solvent; modified hollow silica fine particles 1 (or 11) altered to have affinity to a nonpolar solvent by introduction of an aliphatic hydrocarbon group to the surfaces of the hollow silica fine particles 2; and a polymerization initiator.

The UV-curable resin material composition coating liquid is then layered on the base film 8 using a method such as a coating method, a printing method, and a dipping method, and the solvent is evaporated from the coating layer at a predetermined temperature to form a UV-curable resin material composition layer. The layer is then cured by irradiation of ultraviolet rays to form the low-refractive-index layer 6 in contact with the base film 8.

The most notable feature of the present embodiment is that a nonpolar solvent or a substantially nonpolar mixed solvent, for example, an aliphatic hydrocarbon solvent or alicylic hydrocarbons is used in the preparation of the UV-curable resin material composition coating liquid, and that the modified hollow silica fine particles 1 (or 11), and the a monomer and/or an oligomer thereof having two or more (meth)acryloyl groups are used that are compatible with such solvents. The use of the coating liquid enables formation of the low-refractive-index layer in good adhesion in contact with the base film that has no affinity to polar solvents at all.

For this purpose, the monomer and/or oligomer thereof having two or more (meth)acryloyl groups used to form the low-refractive-index layer 6 are selected from compounds that have affinity to nonpolar solvents, including, for example, bis((meth)acryloyloxy)alkane and tris((meth)acryloyloxy)alkane having a long-chain alkylene backbone, such as 1,9-bis(acryloyloxy)nonane (also known as 1,9-nonanediol diacrylate), and 1,4-bis(acryloyloxymethyl)cyclohexane (also known as 1,4-cyclohexane dimethanol diacrylate). When the monomer contains two (meth)acryloyl groups, a cross-linked structure can be formed between the macromolecular chains, and thus the resin composition 5 formed by polymerization can have improved mechanical strength and hardness. The mechanical strength and hardness of the resin composition 5 can be further improved by using a monomer and/or an oligomer thereof that contain three or more (meth)acryloyl groups.

The modified hollow silica fine particles 1 (or 11) altered to have surface affinity to nonpolar solvents by introduction of an aliphatic hydrocarbon group-containing group 3 to the particle surfaces are used as the hollow silica fine particles that lower the refractive index of the low-refractive-index layer 6.

FIG. 1B is a magnified cross sectional view illustrating a surface structure of the modified hollow silica fine particles 1. The hollow silica fine particles 2 with no surface treatment have the hydroxy group —OH on the surface, and thus have poor affinity to nonpolar solvents. In contrast, the modified hollow silica fine particles 1 have the aliphatic hydrocarbon group-containing group 3 introduced to the surfaces of the hollow silica fine particles 2 by, for example, a condensation reaction with the hydroxy group —OH. In this way, the surfaces of the modified hollow silica fine particles 1 are altered to have affinity to nonpolar solvents.

FIG. 1C is a magnified cross sectional view illustrating a surface structure of the modified hollow silica fine particles 11. The modified hollow silica fine particles 11 differ from the modified hollow silica fine particles 1 in that a group 4 having a polymerizable group polymerizable with the two or more (meth)acryloyl group-containing monomer and/or oligomer thereof is introduced to the particle surface, in addition to the aliphatic hydrocarbon group-containing group 3. In this case, the polymerizable group-containing group 4 polymerizes with the surrounding monomer and/or oligomer in the process of curing the coating layer, and thereby integrates the whole including the modified hollow silica fine particles 11. As a result, the strength and flexibility of the coating film improve. The polymerizable group is preferably, for example, a (meth)acryloyl group or a vinyl group. Note that when the aliphatic hydrocarbon group has a C═C bond, it is not required to additionally introduce the polymerizable group, because the C═C bond serves as the polymerizable group and provides the same effect.

In the UV-curable resin material composition, the contents of the two or more (meth)acryloyl group-containing monomer and/or oligomer thereof, the modified hollow silica fine particles 1 (or 11), and the polymerization initiator are preferably 70 to 30 mass %, 30 to 70 mass %, and 0.1 to 10.0 mass %, respectively. The refractive index of the hollow silica fine particles 2 is preferably 1.1 to 1.4. A sufficient reflection characteristic cannot be obtained when the content of the modified hollow silica fine particles 1 (or 11) is less than 30 mass %. Above 70 mass %, mechanical properties such as abrasion resistance suffer.

The polymerization initiator may be appropriately selected from known materials. The content of the polymerization initiator is preferably 0.1 to 10 mass % of the solid component. A content below 0.1 mass % is practically not suited for industrial production, because photo-curing properties become insufficient. Above 10 mass %, the low-refractive-index layer 6 may leave odor when the quantity of irradiated light is small.

The base film 8 is not particularly limited, and is preferably a base film that shows no affinity to polar solvents, because it maximizes the effects. Examples of the base film 8 include a polyethylene terephthalate (PET) resin film, a triacetyl cellulose (TAC) resin film, and a cycloolefin polymer (COP) resin film. Such resin base films excel in properties such as abrasion resistance, transparency, and heat resistance.

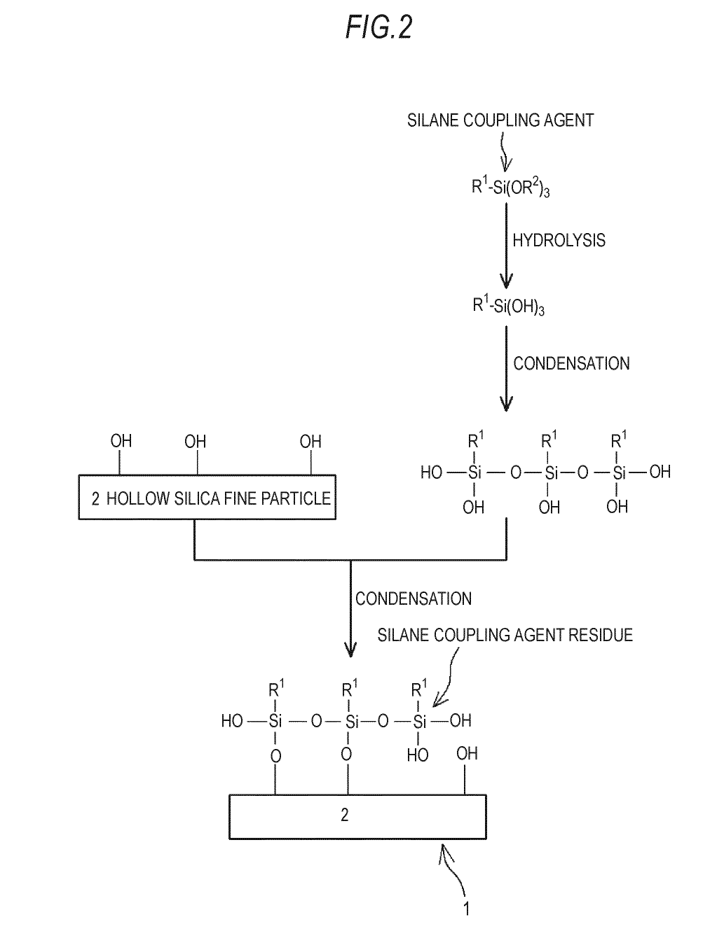

FIG. 2 is an explanatory diagram illustrating the reaction steps for the production of the modified hollow silica fine particles 1 with the use of a silane coupling agent. The silane coupling agent R¹Si(OR²)₃ changes to organic trisilanol R¹Si(OH)₃ by hydrolysis. The organic trisilanol R¹Si(OH)₃ partially undergoes condensation and forms an oligomer. The hydroxy group of the monomer or oligomer of the organic trisilanol undergoes a dehydration condensation reaction with the hydroxy group —OH on the surfaces of the hollow silica fine particles 2. As a result, the linking group —O—Si-bond is formed, and the organic group —R¹ is introduced to the surfaces of the hollow silica fine particles 2 via the linking group.

The silane coupling agent has the following general formula.

General formula of silane coupling agent:

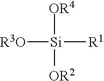

In the general formula, R²=R³=R⁴ for the silane coupling agent of FIG. 2. When the organic group —R¹ is an aliphatic hydrocarbon group, the aliphatic hydrocarbon group can be introduced to the surfaces of the hollow silica fine particles 2 by the foregoing reaction. For example, when octadecyltrimethoxysilane (ODTMS) or octyltrimethoxysilane (OTMS) is used, an octadecyl group or an octyl group can be introduced. When the organic group —R¹ is a group having a polymerizable group, the polymerizable group can be introduced to the surfaces of the hollow silica fine particles 2. For example, when 3-acryloxypropyltrimethoxysilane (ATMS) or vinyltrimethoxysilane (VTMS) is used, an acryloyloxy group or a vinyl group can be introduced.

### Second Embodiment

Examples of the antireflective films and the antireflective film producing methods according to Second Embodiment will be described.

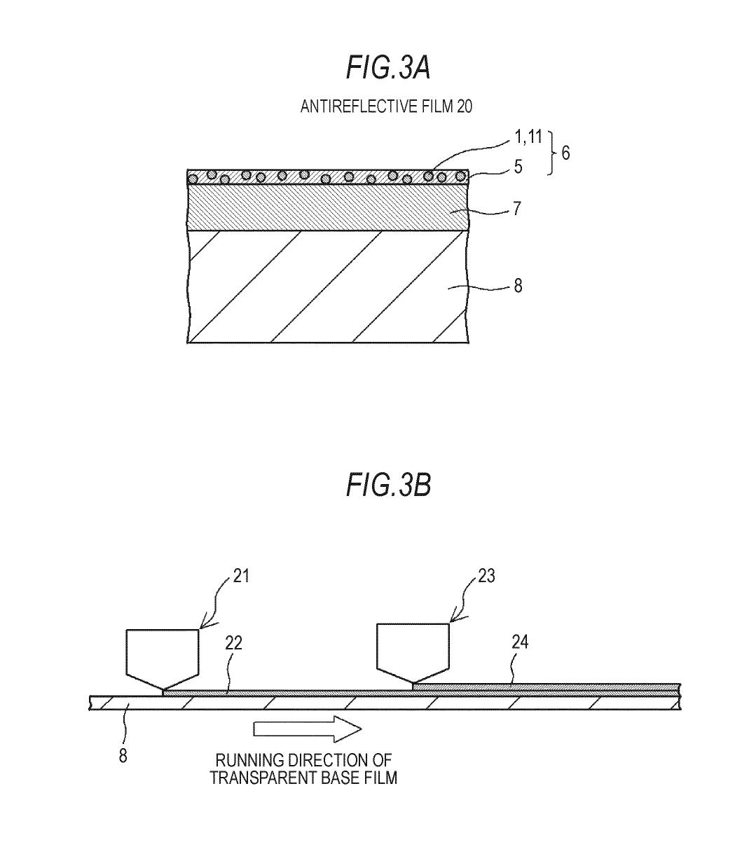

FIG. 3A is a partial cross sectional view illustrating a structure of an antireflective film 20 according to Second Embodiment. The antireflective film 20 is a bilayer film that includes a high-refractive-index layer 7, provided as a functional layer, that has a higher refractive index than the base film 8 and is formed on the base film 8, and a low-refractive-index layer 6 provided in contact with the high-refractive-index layer 7. The bilayer antireflective layer is a layer similar to that described in, for example, JP-A-59-50401. The low-refractive-index layer 6 and the high-refractive-index layer 7 have thicknesses of, for example, 100 nm and 7 μm, respectively.

Preferably, the high-refractive-index layer 7 is a cured layer of a resin material composition layer that includes a two or more (meth)acryloyl group-containing monomer and/or oligomer thereof having affinity to polar solvents, and a polymerization initiator.

The high-refractive-index layer 7 is formed in at least three steps that include:

preparing a coating liquid (hereinafter, “high-refractive-index layer coating liquid”) that contains a UV-curable resin material composition that forms the high-refractive-index layer 7 having a higher refractive index than the base film;

layering the high-refractive-index layer coating liquid on the base film 8; and

curing the high-refractive-index layer-forming resin material composition layer.

In the production of the antireflective film 20 using the method of related art, the UV-curable resin material composition that forms the high-refractive-index layer 7 is dissolved or dispersed in a polar solvent of appropriate polarity to prepare the high-refractive-index layer coating liquid. The coating liquid is then applied onto the base film 8 using a method such as a coating method, a printing method, and a dipping method, and the polar solvent is evaporated at a predetermined temperature to form the UV-curable resin material composition layer. The layer is then cured by irradiation of ultraviolet rays to form the high-refractive-index layer 7 in contact with the base film 8. Thereafter, the low-refractive-index layer 6 is laminated on the high-refractive-index layer 7 in the manner described in the production of the antireflective film 10 in First Embodiment.

The UV-curable resin material composition that forms the high-refractive-index layer 7 may be a composition that includes: an acrylic monomer that contains two or more acryloyl groups per molecule; and a photo-polymerization initiator such as 1-hydroxycyclohexyl phenyl ketone. Examples include dipentaerythritol hexaacrylate (refractive index=1.49), and dimethylol tricyclodecane diacrylate (refractive index=1.50). The composition may further include a leveling agent that improves flatness. The resin material composition is used by being dissolved in a solvent such as cyclohexanone.

As described above, the method employing coating and curing each layer of the laminate including, for example, the high-refractive-index layer and the low-refractive-index layer suffers from poor productivity and increased cost, in addition to lowering interlayer adhesion and abrasion resistance. As a countermeasure, Patent Document 4 proposes an optical film producing method of simultaneously forming a least two optical layers by the steps of simultaneously applying at least two coating layers, and evaporating the solvents of these two or more coating layers after application. The UV-curable resin material composition-containing coating liquid (hereinafter, “low-refractive-index layer coating liquid”) that forms the low-refractive-index layer 6 according to the embodiment uses a nonpolar solvent, and therefore does not easily mix with the high-refractive-index layer coating liquid that uses a polar solvent. Thus, the present invention can be suitably used to simultaneously form the high-refractive-index layer 7 and the low-refractive-index layer 6 using the simultaneous coating method proposed in Patent Document 4.

For this purpose, the method may be adapted to include, for example:

forming the high-refractive-index layer coating liquid using a polar solvent;

layering the high-refractive-index layer coating liquid and the low-refractive-index layer coating liquid simultaneously on the transparent base film 8;

evaporating the solvent from each of the high-refractive-index layer coating layer and the low-refractive-index layer coating layer; and

simultaneously curing the resin material composition layers for the high-refractive-index layer 7 and the low-refractive-index layer 6.

However, in the simultaneous coating method, the solvent that evaporates from the lower layer always passes through the upper layer, and this greatly limits the type of coating liquid that can be used in the simultaneous coating method. This may also lead to poor film quality. These problems are circumvented by the two methods proposed in the present embodiment, as follows.

The first method is a simultaneous coating method, but the high-refractive-index layer coating liquid is formed without a solvent.

The method includes:

simultaneously layering the high-refractive-index layer coating liquid and the low-refractive-index layer coating liquid on the base film 8;

evaporating the nonpolar solvent from the low-refractive-index layer coating liquid layer; and

simultaneously curing the resin material composition layers that form the high-refractive-index layer 7 and the low-refractive-index layer 6.

In this method, because the high-refractive-index layer coating liquid does not contain a solvent, the evaporation of the lower layer (high-refractive-index layer coating liquid) solvent does not take place through the upper layer (low-refractive-index layer coating liquid). Because there is no evaporation of the lower layer solvent through the upper layer, there will be no large limitations on the applicability of the coating liquid, or lowering of film quality.

It should be noted, however, that the (meth)acryloyl group-containing monomer and/or oligomer thereof that forms the high-refractive-index layer 7 needs to be a liquid, specifically, a non-solvent type (meth)acrylic UV-curable resin monomer and/or oligomer thereof with poor affinity to nonpolar solvents, for example, such as ethoxylated trimethylolpropane triacrylate.

The second method forms the high-refractive-index layer coating liquid with a polar solvent, and includes the steps of:

layering the high-refractive-index layer coating liquid on the base film 8;

layering the low-refractive-index layer coating liquid layer on the high-refractive-index layer coating layer with a time lag so that at least part of the polar solvent has the time to evaporate from the high-refractive-index layer coating liquid layer;

evaporating the solvents from the high-refractive-index layer coating liquid layer and the low-refractive-index layer coating liquid layer; and

simultaneously curing the resin material composition layers that form the high-refractive-index layer and the low-refractive-index layer.

In the time-lag coating method, because of the time lag that allows at least part of the polar solvent to evaporate from the high-refractive-index layer coating liquid layer, less solvent evaporates from the lower layer (high-refractive-index layer coating liquid) through the upper layer (low-refractive-index layer coating liquid). Accordingly, the large limitations imposed on applicability of the coating liquid by the evaporation of the lower layer solvent through the upper layer, and possible lowering of film quality will not be as frequent as that in the simultaneous coating method proposed in Patent Document 4.

The polar solvent used for the high-refractive-index layer coating liquid preferably has polarity to such an extent that the high-refractive-index layer coating liquid and the low-refractive-index layer coating liquid do not form a homogenous mixture. Note, however, that it is not preferable for the polar solvent to have very large polarity, because the polar solvent needs to be moderately dissolved in the nonpolar solvent of the low-refractive-index layer coating liquid in order to evaporate through the low-refractive-index layer coating liquid. For this reason, for example, ketones, esters, ethers, alcohols, for example, such as butyl acetate, cyclohexanone, and t-butyl alcohol, are preferably used for the polar solvent of the high-refractive-index layer coating liquid. The UV-curable resin that forms the high-refractive-index layer coating liquid is preferably a resin that contains two or more (meth)acryloyl groups per monomer molecule, and that is poorly soluble in nonpolar solvents, and soluble in polar solvents. Commercially available products, for example, such as a UV-curable multifunctional urethane acrylate oligomer (KAYARAD DPHA-40H; Nippon Kayaku Co., Ltd.), and UV-1700B (Nippon Synthetic Chemical Industry Co., Ltd.) can be used. The polymerization initiator and the leveling agent can be appropriately selected from known materials.

FIG. 3B is a schematic diagram illustrating the gist of the time-lag coating method according to Second Embodiment. The apparatus illustrated in FIG. 3B includes a lower layer coating section 21 that layers a high-refractive-index layer coating layer 22 on the base film 8, and an upper layer coating section 23 that layers a low-refractive-index layer coating layer 24 on the high-refractive-index layer coating layer 22. The lower layer coating section 21 and the upper layer coating section 23 are disposed with a predetermined distance in between. The transparent base film 8 is adapted to run past the lower layer coating section 21 and the upper layer coating section 23 in order. The high-refractive-index layer coating layer 22 and the low-refractive-index layer coating layer 24 are sequentially formed with good productivity as the transparent base film 8 runs past these sections. The time-lag between the formation of the high-refractive-index layer coating layer 22 and the formation of the low-refractive-index layer coating layer 24 is desirably set according to the distance between the lower layer coating section 21 and the upper layer coating section 23, and the running speed of the transparent base film 8 between these sections.

### Examples

Examples of the embodiments are described below.

### Example 1

Surface-untreated silica fine particles easily agglomerate in nonpolar solvents and in solvents of low polarity, such as in hexane. In order to desirably disperse silica fine particles in nonpolar solvents or low-polarity solvents without agglomeration, alteration is necessary that renders the surfaces of the silica fine particles lipophilic. Example 1 describes alteration of the hollow silica fine particle surface with a silane coupling agent (First Embodiment, FIG. 2). The modified hollow silica fine particles with the altered lipophilic surface by the silane coupling agent are preferable as the modified hollow silica fine particles 1 added to the low-refractive-index layer 6 described in First and Second Embodiments.

### Example 1-1

Surface-untreated hollow silica fine particles were subjected to surface treatment as follows.

(1) Materials were mixed in the following order.

Ethanol: 10.75 g

Octadecyltrimethoxysilane (ODTMS): 0.56 g

Water: 1 g

Surface-untreated hollow silica fine particle (average particle size, 50 nm) sol (solid component, 20 mass %): 1.25 g

28 Mass % ammonia water: 1.5 g

The dispersion liquid mixture was semi-transparent. The ODTMS was obtained from Sigma-Aldrich Japan. Surulia 1110 (Nikki Shokubai Kasei) was used as the sol. Surulia 1110 is a sol dispersion of surface-untreated hollow silica fine particles (average particle size, 50 nm) in 2-propanol (IPA) with a solid component concentration of 20 mass %.

(2) The mixture was stirred at room temperature for 1.5 hours under irradiation of ultrasonic waves. The dispersion liquid turned into a gel (became clouded) after the stirring. This is believed to be the result of the reaction between the ODTMS and the hydroxyl groups on the surfaces of the hollow silica fine particles, and the subsequent formation of the modified hollow silica fine particles with their surfaces altered by the ODTMS residue (hereinafter, simply “ODTMS-modified hollow silica fine particles”).

(3) The majority of the liquid component was removed from the dispersion liquid by centrifugation to obtain a hydrous solid cake.

(4) Hexane was added to the solid, and the mixture was stirred at room temperature for 1 hour under irradiation of ultrasonic waves.

(5) By filtration with a filter having a pore size of 0.2 μm, the solid component larger than this pore size was removed.

(6) The ODTMS-modified hollow silica fine particles that passed through the filter was dispersed in hexane, and the resulting sol (hereinafter, “hexane sol”) was preserved. The hexane sol appeared semi-transparent under visual inspection.

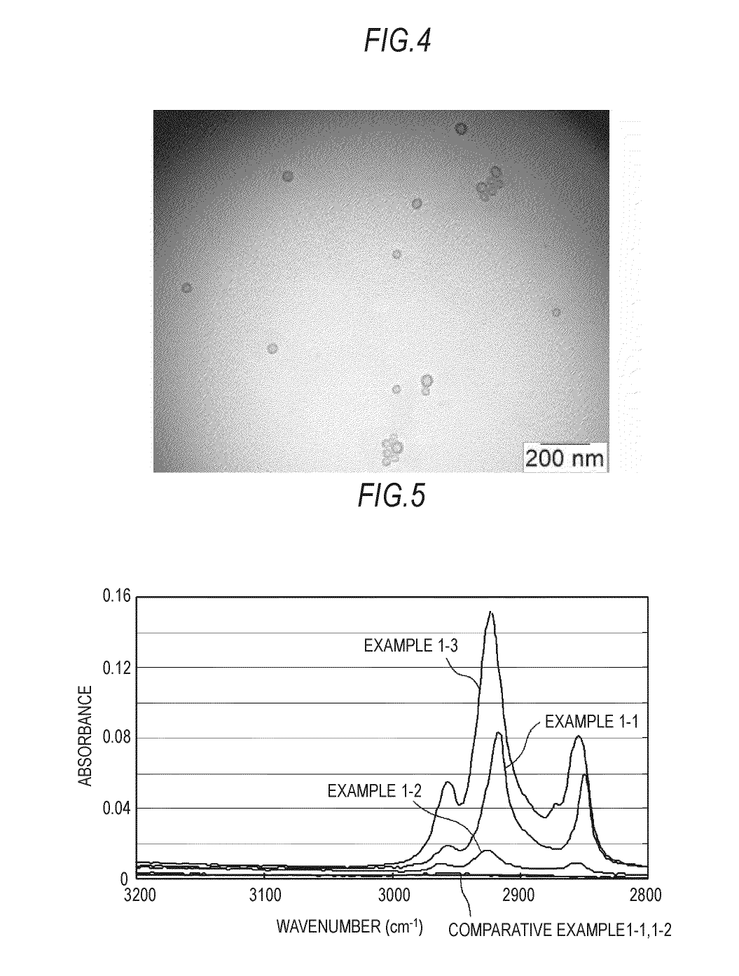

FIG. 4 is the transmission electron microscope (TEM) observed image of the ODTMS-modified hollow silica fine particle hexane sol obtained in Example 1-1. It can be seen that the ODTMS-modified hollow silica fine particles are in a desirably dispersed state in hexane.

FIG. 5 shows an IR (infrared) absorption spectrum of powdery ODTMS-modified hollow silica fine particles after evaporation of the solvent. It can be seen that the spectrum has an absorption peak near 3,000 cm⁻¹ characteristic of a methyl group or a methylene group, suggesting the binding of the ODTMS residue to the surfaces of the hollow silica fine particles. A heat analysis of the powdery ODTMS-modified hollow silica fine particles at 500° C. for 30 minutes found that the percentage mass reduction was 44.4%. The mass reduction is believed to be the result of the heat decomposition and removal of the surface-bound ODTMS residue.

### Comparative Example 1-1

Powdery surface-untreated hollow silica fine particles obtained by evaporating the solvent from Surulia 1110 were added to hexane, and the mixture was stirred under irradiation of ultrasonic waves. The hollow silica fine particles settled under visual inspection, and the surface-untreated hollow silica fine particles were not dispersible in hexane.

FIG. 5 shows an IR absorption spectrum of the powdery surface-untreated hollow silica fine particles after evaporation of the solvent. It can be seen that the absorption peak near 3,000 cm⁻¹ characteristic of a methyl group or a methylene group is absent in the spectrum, suggesting the absence of an alkyl or other groups binding to the surfaces of the hollow silica fine particles. A heat analysis of the powdery surface-untreated hollow silica fine particles at 500° C. for 30 minutes found that the percentage mass reduction was 13.1%. The mass reduction is believed to be the result of the desorption of the water adsorbed to the surfaces, or the loss of water due to dehydration reaction of the hydroxyl groups.

### Comparative Example 1-2

After evaporating the solvent from Surulia 06SN (available from Nikki Shokubai Kasei; the IPA sol of fine particles produced by vinyl-modifying the surfaces of hollow silica fine particles having an average particle size of 50 nm; solid component, 20 mass %), the powdery vinyl-modified hollow silica fine particles were added to hexane, and stirred under irradiation of ultrasonic waves. The hollow silica fine particles settled under visual inspection, and the vinyl-modified hollow silica fine particles were not dispersible in hexane.

FIG. 5 shows an IR absorption spectrum of the powdery vinyl-modified hollow silica fine particles. It can be seen that the absorption peak near 3,000 cm⁻¹ characteristic of a methyl group or a methylene group is absent in the spectrum, suggesting the absence of an alkyl, alkylene, or other groups binding to the surfaces of the hollow silica fine particles.

### Comparative Example 1-3

The hollow silica fine particles were subjected to surface treatment under the conditions of Example 1-1, except that the 28 mass % ammonia water was used in an amount ⅕ of that used in Example 1-1. The hollow silica fine particles settled under visual inspection, and the ODTMS-modified hollow silica fine particles obtained in Comparative Example 1-3 were not dispersible in hexane. This is probably due to the smaller amount of ammonia water relative to that used in Example 1-1, and the corresponding reduction in the amount of ODTMS residue that was able to bind to the surfaces of the silica fine particles, failing to sufficiently render the silica fine particle surfaces lipophilic.

### Comparative Example 1-4

The hollow silica fine particles were subjected to surface treatment under the conditions of Example 1-1, except that the ODTMS used in Example 1-1 was replaced with oleic acid. The hollow silica fine particles settled under visual inspection, and the surface-treated hollow silica fine particles of Comparative Example 1-4 were not dispersible in hexane. This is probably due to the negatively charged surfaces of the silica fine particles, preventing the carboxylate group —COO⁻ of the oleic acid from being adsorbed onto the surfaces of the silica fine particles. Note that the surface potential of the silica fine particles becomes negative when the pH of the reaction field is 2 or higher.

### Example 1-2

The hollow silica fine particles were subjected to surface treatment under the conditions of Example 1-1, except that 0.56 g of octyltrimethoxysilane (OTMS; Sigma-Aldrich Japan) was used instead of 0.56 g of ODTMS used in Example 1-1. The resulting hexane sol appeared semi-transparent under visual inspection. This is probably due to the reaction between OTMS and the hydroxyl groups on the surfaces of the hollow silica fine particles, producing modified hollow silica fine particles whose surfaces have been altered by the OTMS residue (hereinafter, simply “OTMS modified hollow silica fine particles”).

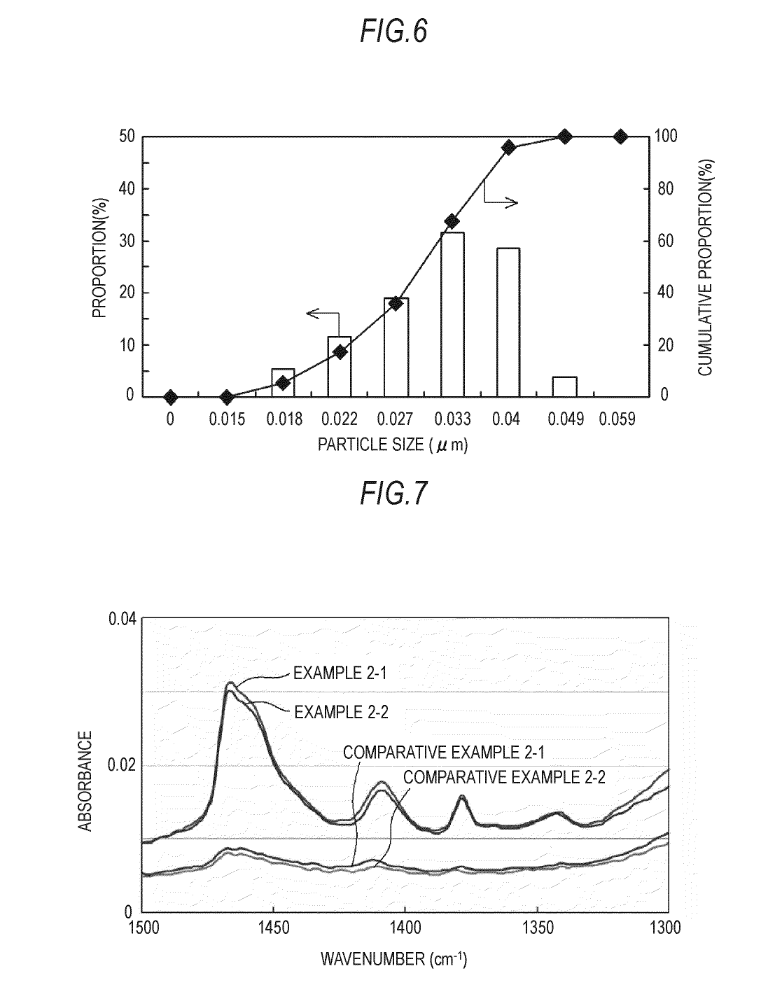

FIG. 6 is a graph representing the particle size distribution of the OTMS-modified hollow silica fine particles in the hexane sol obtained in Example 1-2. The particle size distribution was measured using an SALD-7000 (Shimadzu Corporation). It can be seen from FIG. 6 that the OTMS-modified hollow silica fine particles contain primary particles that are desirably dispersed in hexane.

FIG. 5 shows an IR absorption spectrum of powdery OTMS-modified hollow silica fine particles after evaporation of the solvent. It can be seen that the spectrum has an absorption peak near 3,000 cm⁻¹ characteristic of a methyl group or a methylene group, suggesting the binding of the OTMS residue to the surfaces of the hollow silica fine particles. A heat analysis of the powdery OTMS-modified hollow silica fine particles at 500° C. for 30 minutes found that the percentage mass reduction was 36.6%. The mass reduction is believed to be the result of the heat decomposition and removal of the surface-bound OTMS residue.

### Comparative Example 1-5

The hollow silica fine particles were subjected to surface treatment under the conditions of Example 1-2, except that the OTMS was added in an amount 1/10 of that used in Example 1-2. The hollow silica fine particles settled under visual inspection, and the OTMS-modified hollow silica fine particles obtained in Comparative Example 1-5 were not dispersible in hexane. This is probably due to the smaller amount of OTMS relative to that used in Example 1-2, and the corresponding reduction in the amount of OTMS residue that was able to bind to the surfaces of the silica fine particles, failing to sufficiently render the silica fine particle surfaces lipophilic.

### Example 1-3

0.56 g of Surulia 4110 (available from Nikki Shokubai Kasei) was used instead of 0.56 g of Surulia 1110 used in Example 1-2. Surulia 4110 is a sol with surface-untreated hollow silica fine particles (average particle size, 60 nm) dispersed in 2-propanol (IPA) at a solid component concentration of 20 mass %. Except for Surulia 4110, the hollow silica fine particles were subjected to surface treatment as in Example 1-2. The resulting hexane sol appeared semi-transparent under visual inspection. A heat analysis of the powdery OTMS-modified hollow silica fine particles at 500° C. for 30 minutes after evaporation of the solvent found that the percentage mass reduction was 38.2%. It is inferred from this that the OTMS residue has bound to the hollow silica fine particles in substantially the same amount as that seen in Example 1-2.

Table 1 below presents the reaction mixture compositions used in the surface treatments of Examples 1-1 to 1-3 and Comparative Examples 1-1 to 1-5, and the properties of the resulting hollow silica fine particles.

TABLE 1

| | | | | Comparative | Comparative | Comparative |
|---|---|---|---|---|---|---|
| | | | Example 1-1 | Example 1-1 | Example 1-2 | Example 1-3 |
| Reaction liquid | Hollow silica fine | Surface | Untreated | Untreated | Vinyl-modified | Untreated |
| composition | particles, 1.25 g | treatment | | | | |
| | | Particle size | 50 | 50 | 50 | 50 |
| | | (nm) | | | | |

| | | | | | |
|---|---|---|---|---|---|
| | Surface treatment agent, 0.56 g | ODTMS | — | — | ODTMS |
| | Water, 1 g | Same as on | — | — | Same as |
| | | the left | | | Example 1-1 |
| | 28 mass % ammonia water, 1.5 g | Same as on | — | — | ⅕ |
| | | the left | | | |
| | Ethanol, 10.75 g | Same as on | — | — | Same as |
| | | the left | | | Example 1-1 |
| Properties | Dispersibility in hexane | Semi- | Settled, poor | Settled, poor | Settled, poor |
| | | transparent, | | | |
| | | good | | | |
| | TEM observation | Dispersed | — | — | — |
| | Peak characteristic of CH₂ or CH₃ | Present | Absent | Absent | — |
| | Heat analysis, change in mass (%) | 44.4 | 13.1 | — | — |

| | | | Comparative | | Comparative | |
|---|---|---|---|---|---|---|
| | | | Example 1-4 | Example 1-2 | Example 1-5 | Example 1-3 |
| Reaction liquid | Hollow silica fine | Surface | Untreated | Untreated | Untreated | Untreated |
| composition | particles, 1.25 g | treatment | | | | |
| | | Particle size | 50 | 50 | 50 | 60 |
| | | (nm) | | | | |

| | | | | | |
|---|---|---|---|---|---|
| | Surface treatment agent, 0.56 g | Oleic acid | OTMS | OTMS, 1/10 | OTMS |
| | Water, 1 g | Same as on | Same as on | Same as on | Same as on |
| | | the left | the left | the left | the left |
| | 28 mass % ammonia water, 1.5 g | Same as on | Same as on | Same as on | Same as on |
| | | the left | the left | the left | the left |
| | Ethanol, 10.75 g | Same as on | Same as on | Same as on | Same as on |
| | | the left | the left | the left | the left |
| Properties | Dispersibility in hexane | Settled, poor | Semi- | Settled, poor | Semi- |
| | | | transparent, | | transparent, |
| | | | good | | good |
| | Particle size distribution | — | Primary | — | — |
| | | | particle | | |
| | | | dispersion | | |
| | Peak characteristic of CH₂ or CH₃ | — | Present | — | — |
| | Heat analysis, change in mass (%) | — | 36.6 | — | 38.2 |

### Example 2

Example 2 describes modified hollow silica fine particles 11 having an aliphatic hydrocarbon group and a polymerizable group (see FIG. 1C), produced by the surface treatment of the OTMS-modified hollow silica fine particles of Examples 1-2 and 1-3 using a polymerizable group-containing silane coupling material for the purpose of improving film strength and the affinity to the UV-curable resin monomer and/or oligomer thereof. The hollow silica fine particles with the surface-bound polymerizable group are preferable as the hollow silica fine particles 11 added to the low-refractive-index layer 6.

### Example 2-1

The OTMS-modified hollow silica fine particles were surface-treated as follows.

(1) Materials were mixed in the following order.

OTMS-modified hollow silica fine particle sol produced in Example 1-2: 5 g

IPA: 7 g

3-Acryloyloxypropyltrimethoxysilane (ATMS): 0.53 g

Water: 1 g

Acetic acid: 0.131 g (pH=5.3 after the addition of all components)

The dispersion liquid mixture was semi-transparent. The sol is a sol prepared by adding IPA to the hexane sol of the OTMS-modified hollow silica fine particles produced in Example 1-2 (hexane:IPA mass ratio=1:1) at a solid component concentration of 5 mass %. KBM 5103 (Shin-Etsu Chemical Co., Ltd.) was used as the ATMS.

(2) The mixture was stirred at room temperature for 1.5 hours under irradiation of ultrasonic waves. The dispersion liquid turned into a gel (became clouded) after the stirring. This is believed to be the result of the reaction between the ATMS and the hydroxyl groups on the surfaces of the silica fine particles, and the subsequent formation of the hollow silica fine particles with their surfaces bound to the OTMS residue and the introduced ATMS residue (hereinafter, “OTMS•ATMS-modified hollow silica fine particles).

(3) The majority of the liquid component was removed from the dispersion liquid by centrifugation to obtain a hydrous solid cake.

(4) Hexane was added to the solid, and the mixture was stirred at room temperature for 1 hour under irradiation of ultrasonic waves.

(5) By filtration with a filter having a pore size of 0.2 μm, the solid component larger than this pore size was removed.

(6) The hexane sol of the OTMS•ATMS-modified hollow silica fine particles that passed through the filter was preserved. The hexane sol appeared semi-transparent under visual inspection.

FIG. 7 shows the IR absorption spectrum of the powdery OTMS•ATMS-modified hollow silica fine particles prepared by evaporating the solvent from the hexane sol. The spectrum has the absorption peak near 3,000 cm⁻¹ characteristic of a methyl group or a methylene group, suggesting the presence of the OTMS residue that had bound to the hollow silica fine particle surfaces first. An absorption peak is also present near 1,400 cm⁻¹ characteristic of a C═C bond, suggesting the binding of the ATMS residue to the hollow silica fine particle surfaces. Specifically, these results suggest the formation of the OTMS•ATMS-modified hollow silica fine particles.

A heat analysis of the powdery OTMS•ATMS-modified hollow silica fine particles at 500° C. for 30 minutes found that the percentage mass reduction was 24.8%. The mass reduction is believed to be the result of the heat decomposition and removal of the surface-bound OTMS and ATMS residues.

### Example 2-2

0.56 g of Vinyltrimethoxysilane (VTMS) was used instead of 0.56 g of ATMS used in Example 2-1. Except for VTMS, the hollow silica fine particles were subjected to surface treatment as in Example 2-1. The resulting sol appeared semi-transparent under visual inspection. KBM 1003 (Shin-Etsu Chemical Co., Ltd.) was used as the VTMS.

FIG. 7 shows the IR absorption spectrum of the powdery OTMS•VTMS-modified hollow silica fine particles prepared by evaporating the solvent from the hexane sol. The spectrum has the absorption peak near 3,000 cm⁻¹ characteristic of a methyl group or a methylene group, and the absorption peak near 1,400 cm⁻¹ characteristic of a C═C bond as in Example 2-1, suggesting the formation of the OTMS•VTMS-modified hollow silica fine particles.

### Comparative Example 2-1

The hollow silica fine particles were subjected to surface treatment under the conditions of Example 2-1, except that 7 g of IPA used in Example 2-1 was replaced with 7 g of hexane. The resulting sol appeared semi-transparent under visual inspection, and the hollow silica fine particles were dispersible.

FIG. 7 shows the IR absorption spectrum of the powdery modified hollow silica fine particles prepared by evaporating the solvent from the hexane sol. While the spectrum has the absorption peak near 3,000 cm⁻¹ characteristic of a methyl group or a methylene group, the absorption peak near 1,400 cm⁻¹ characteristic of a C═C bond, observed in Example 2-1, is absent. This suggests that there is almost no binding between the ATMS residue and the silica fine particles. It is believed that this is the result of the large amount of hexane contained in the reaction liquid, causing the water, which otherwise would have been used for hydrolysis, to undergo phase separation from the reaction liquid, and failing to sufficiently promote silane coupling reaction. The phase separation of the water in the reaction liquid was confirmed by visual inspection.

### Comparative Example 2-2

The hollow silica fine particles were subjected to surface treatment under the conditions of Example 2-2, except that 7 g of hexane was used instead of 7 g of IPA used in Example 2-1. The resulting sol appeared semi-transparent under visual inspection, and the hollow silica fine particles were dispersible.

FIG. 7 shows the IR absorption spectrum of the powdery modified hollow silica fine particles prepared by evaporating the solvent from the hexane sol. While the spectrum has the absorption peak near 3,000 cm⁻¹ characteristic of a methyl group or a methylene group, the absorption peak near 1,400 cm⁻¹ characteristic of a C═C bond, observed in Example 2-2, is absent. This suggests that there is almost no binding between the VTMS residue and the silica fine particles. It is believed that this is the result of the large amount of hexane contained in the reaction liquid, causing the water, which otherwise would have been used for hydrolysis, to undergo phase separation from the reaction liquid, and failing to sufficiently promote silane coupling reaction, as in Comparative Example 2-1. The phase separation of the water in the reaction liquid was confirmed by visual inspection.

From these results, the composition of the reaction liquid is very important to change the OTMS-modified hollow silica fine particles to the OTMS•ATMS-modified hollow silica fine particles or OTMS•VTMS-modified hollow silica fine particles. Considering only that the particles are OTMS-modified particles that are dispersible in hexane, the reaction liquid is preferably hexane so that the reaction can proceed in the maintained dispersed state. The reaction, however, requires addition of water for hydrolysis. Because water is insoluble in hexane, the reaction liquid is required to include a compatible component. IPA serves this purpose. (The OTMS-modified hollow silica fine particles powder was tested for its dispersibility in t-butyl alcohol, methyl ethyl ketone, ethanol, and IPA, of which IPA produced the most desirable result while all the other components yielded undesirable results.) Specifically, the constituting materials required for the reaction liquid are (1) hexane required to maintain the dispersed state, and (2) the compatibilizing agent IPA required to dissolve water in the reaction liquid for hydrolysis.

The hexane-to-IPA mixture ratio has an optimum range. As demonstrated in Examples 2-1 and 2-2, the reaction effectively proceeds at the hexane:IPA=9.25:2.5, whereas the reaction does not proceed at the hexane:IPA=9.25:2.5 as described in Comparative Examples 2-1 and 2-2.

### Example 2-3

The OTMS-modified hollow silica fine particles (particle size, 60 nm) hexane sol produced in Example 1-3 was used instead of the OTMS-modified hollow silica fine particles (particle size, 50 nm) hexane sol produced in Example 1-2. Except for this, the OTMS•ATMS-modified hollow silica fine particles hexane sol was produced as in Example 2-1. The resulting hexane sol appeared semi-transparent under visual inspection.

A heat analysis of the OTMS•ATMS-modified hollow silica fine particles after evaporation of the solvent from the hexane sol at 500° C. for 30 minutes found that the percentage mass change was 24.1%. The mass change is believed to be the result of the binding of the OTMS residue and the ATMS residue in substantially the same amounts as those in Example 2-1.

Table 2 below presents the reaction mixture compositions used in the surface treatments of Examples 2-1 to 2-3 and Comparative Examples 2-1 and 2-2, and the properties of the resulting modified hollow silica fine particles.

TABLE 2

| | | | | | Comparative | Comparative | |
|---|---|---|---|---|---|---|---|
| | | | Example 2-1 | Example 2-2 | Example 2-1 | Example 2-2 | Example 2-3 |
| Reaction liquid | Modified hollow | Surface | OTMS | OTMS | OTMS | OTMS | OTMS |
| composition | silica fine | treatment | | | | | |
| | particle sol, 5 g | Particle size | 50 | 50 | 50 | 50 | 60 |
| | | (nm) | | | | | |

| | | | | | | |
|---|---|---|---|---|---|---|
| | Additional surface treatment | ATMS | VTMS | ATMS | VTMS | ATMS |
| | agent, 0.53 g | | | | | |
| | Solvent, 7 g | IPA | IPA | Hexane | Hexane | IPA |
| | Water, 1 g | Same as on | Same as on | Same as on | Same as on | Same as on |
| | | the left | the left | the left | the left | the left |
| | Acetic acid, 0.131 g | Same as on | Same as on | Same as on | Same as on | Same as on |
| | | the left | the left | the left | the left | the left |
| Properties | Dispersibility in hexane | Semi-transparent, | Semi-transparent, | Semi-transparent, | Semi-transparent, | Semi-transparent, |
| | | good | good | good | good | good |
| | Peak characteristic of CH₂ or | Present | Present | Present | Present | Present |
| | CH₃ | | | | | |
| | peak characteristic of C═C | Present | Present | Absent | Absent | Present |
| | Heat analysis, change in mass (%) | 24.8 | — | — | — | 24.1 |

### Example 3

The modified hollow silica fine particles produced in Example 2-3 and Examples 1-1 to 1-3 were used to produce the antireflective film 10 having the monolayer antireflective layer of the low-refractive-index layer 6 described in First Embodiment. The films were evaluated with regard to optical properties (including reflectance, haze, and total light transmission), and mechanical property.

### Example 3-1

First, 10 mass % hexane sol of the OTMS•ATMS-modified hollow silica fine particles produced in Example 2-3 was used to prepare a UV-curable resin material composition coating liquid. The contents of the respective components of the UV-curable resin material composition coating liquid are as follows.

<UV-Curable Resin Material Composition Coating Liquid>

1,9-Bis(acryloyloxy)nonane: 0.045 g

10 Mass % hexane sol of OTMS•ATMS-modified hollow silica fine particles: 0.5 g

1-Hydroxycyclohexyl phenyl ketone: 0.005 g

Hexane: 7.45 g

The coating liquid contained a 1.25 mass % solid component. The content of the modified silica fine particles in the solid component was 50 mass %.

1,9-Bis(acryloyloxy)nonane is a UV-curable resin monomer having affinity to nonpolar solvents, and the light acrylate 1,9-NDA (Kyoeisha Chemical Co., Ltd.) was used therefor. The 1-hydroxycyclohexyl phenyl ketone is a photo-polymerization initiator, for which IRGACURE 184 (Ciba Japan) was used. The hexane is a nonpolar solvent.

The low-refractive-index layer was formed on a TAC base film in the following order.

(1) The UV-curable resin material composition coating liquid was coated on a TAC base film using a bar coater.

(2) The solvent was evaporated by a heat treatment performed in an oven at 80° C. for 90 seconds, and the UV-curable resin material composition layer was formed.

(3) The UV-curable resin material composition layer was cured by irradiation of ultraviolet rays in a purged N₂ environment under a cumulative light quantity of 300 mJ, so as to form the low-refractive-index layer 6.

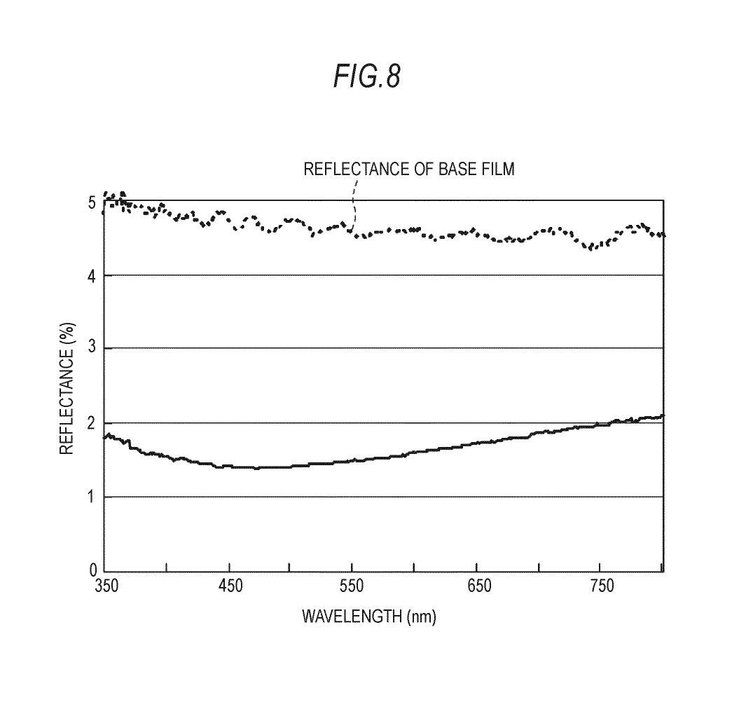

FIG. 8 is a graph representing the reflectance of the antireflective film that includes the low-refractive-index layer on the TAC substrate. The dotted line represents the reflectance of the TAC substrate without the low-refractive-index layer. As is clear from FIG. 8, the low-refractive-index layer has antireflection performance. The lowest reflectance of the TAC substrate provided with the low-refractive-index layer was 1.4%. Other optical properties were also desirable, with the haze of 1% or less, and the total light transmission of 90% or more. The result of cotton swab rubbing, a test of mechanical property, was also desirable. The test results for these properties are presented below.

<Optical Properties>

Lowest reflectance: 1.4%; haze: 0.7%; total light transmission: 93.5%

<Mechanical Property>

Cotton swab rubbing: Good

### Example 3-2

The ODTMS-modified hollow silica fine particles produced in Example 1-1 were used instead of the OTMS•ATMS-modified hollow silica fine particles used in Example 3-1. Other than this, the low-refractive-index layer was formed as in Example 3-1.

The low-refractive-index layer produced in Example 3-2 had the haze as large as 2.6%, and the result of cotton swab rubbing was poor. Overall, the low-refractive-index layer of Example 3-2 were interior to the low-refractive-index layer of Example 3-1 in terms of optical and mechanical properties. The test results for these properties are presented below.

<Optical Properties>

Lowest reflectance: 1.5%; haze: 2.6%; total light transmission: 92.9%

<Mechanical Property>

Cotton swab rubbing: Poor

### Example 3-3

The OTMS-modified hollow silica fine particles produced in Example 1-2 were used instead of the OTMS•ATMS-modified hollow silica fine particles used in Example 3-1. Other than this, the low-refractive-index layer was formed as in Example 3-1.

The low-refractive-index layer produced in Example 3-3 had the lowest reflectance as high as 1.7%, and the result of cotton swab rubbing was poor. Overall, the low-refractive-index layer of Example 3-3 was inferior to the low-refractive-index layer of Example 3-1 in terms of optical and mechanical properties. The test results for these properties are presented below.

<Optical Properties>

Lowest reflectance: 1.7%; haze: 0.6%; total light transmission: 92.2%

<Mechanical Property>

Cotton swab rubbing: Poor

### Example 3-4

The OTMS-modified hollow silica fine particles produced in Example 1-3 were used instead of the OTMS•ATMS-modified hollow silica fine particles used in Example 3-1. Except for this, the low-refractive-index layer was formed as in Example 3-1.

The low-refractive-index layer produced in Example 3-4 outperformed the low-refractive-index layer of Example 3-1 in terms of lowest reflectance and total light transmission. However, the mechanical property was inferior as demonstrated by the poor result for cotton swab rubbing. The test results for these properties are presented below.

<Optical Properties>

Lowest reflectance: 1.3%; haze: 0.8%; total light transmission: 94.4%

<Mechanical Property>

Cotton swab rubbing: Poor

Tables 3 below presents the compositions of the coating liquids, and the properties of the antireflective films of Examples 3-1 to 3-4.

TABLE 3

| | | | Example 3-1 | Example 3-2 | Example 3-3 | Example 3-4 |
|---|---|---|---|---|---|---|
| Content | 1,9-NDA, 0.045 g | | Same as on | Same as on | Same as on | Same as on |
| | | | the left | the left | the left | the left |
| | Modified | Surface | OTMS•ATMS | ODTMS | OTMS | OTMS |
| | hollow silica | treatment | | | | |
| | sol, 5 g | Particle size | 60 | 50 | 50 | 60 |
| | | (nm) | | | | |
| | Irgacure 184, 0.05 g | | Same as on | Same as on | Same as on | Same as on |
| | | | the left | the left | the left | the left |
| | Hexane, 7.4 g | | Same as on | Same as on | Same as on | Same as on |
| | | | the left | the left | the left | the left |
| Properties | Optical | Lowest | 1.4 | 1.5 | 1.7 | 1.3 |
| | properties | reflectance | | | | |
| | | Haze | 0.7 | 2.6 | 0.6 | 0.8 |
| | | Total light | 93.5 | 92.9 | 92.2 | 94.4 |
| | | transmission | | | | |

| | | | | |
|---|---|---|---|---|
| Cotton swab rubbing | Good | Poor | Poor | Poor |

### Example 4

The antireflective film 20 having the antireflective layer of the bilayer structure including the high-refractive-index layer 7 (lower layer) and the low-refractive-index layer 6 (upper layer) described in Second Embodiment was produced. The antireflective layer was formed using a simultaneous coating method, a time-lag coating method, and a sequential forming method, and evaluated with regard to optical properties (reflectance, haze, total light transmission) and mechanical properties. The low-refractive-index layer 6 was produced using the OTMS•ATMS-modified hollow silica fine particles, which produced the highest-performance low-refractive-index layer in Example 3.

### Example 4-1

In Example 4-1, the high-refractive-index layer (lower layer) and the low-refractive-index layer (upper layer) were formed using a simultaneous coating method.

First, the low-refractive-index layer-forming UV-curable resin material composition coating liquid was prepared using a 10 mass % hexane sol of the OTMS•ATMS-modified hollow silica fine particles (average particle size, 60 nm) produced in Example 2-3. The contents of the respective components of the coating liquid are as follows.

<Low-Refractive-Index Layer-Forming UV-Curable Resin Material Composition Coating Liquid>

1,9-Bis(acryloyloxy)nonane: 0.045 g

10 Mass % hexane sol of OTMS•ATMS-modified hollow silica fine particles: 0.5 g

1-Hydroxycyclohexyl phenyl ketone: 0.005 g

Hexane: 1.07 g

IPA: 0.38 g

The coating liquid contained a 5 mass % solid component. The content of the modified silica fine particles in the solid component was 50 mass %.

A solvent-free coating liquid was prepared as the high-refractive-index layer-forming UV-curable resin material composition coating liquid, as follows.

<High-Refractive-Index Layer-Forming UV-Curable Resin Material Composition Coating Liquid>

Ethoxylated trimethylolpropane triacrylate: 1.9 g

1-Hydroxycyclohexyl phenyl ketone: 0.1 g

The product A-TMPT-3EO (Shin-Nakamura Chemical Co., Ltd.) was used as the ethoxylated trimethylolpropane triacrylate.

The high-refractive-index layer (lower layer) and the low-refractive-index layer (upper layer) were laminated on the base film in the following order.

(1) The high-refractive-index layer-forming UV-curable resin material composition coating liquid and the low-refractive-index layer-forming UV-curable resin material composition coating liquid were simultaneously coated as the lower layer and the upper layer on the base film using a coater.

(2) The solvent was evaporated by a heat treatment performed at 80° C. for 90 seconds in an oven, and the low-refractive-index layer-forming UV-curable resin material composition layer was formed.

(3) Each UV-curable resin material composition layer was cured by irradiation of ultraviolet rays in a purged N₂ environment at a cumulative light quantity of 300 mJ, so as to form the high-refractive-index layer (lower layer) and the low-refractive-index layer (upper layer).

The conditions of the simultaneous layer coating are as follows.

Gap length between coating section and transparent base film: 100 μm

Running speed of transparent base film: 0.5 m/min

The Diafoil O300E100 (Mitsubishi Polyester Film) was used as the base film.

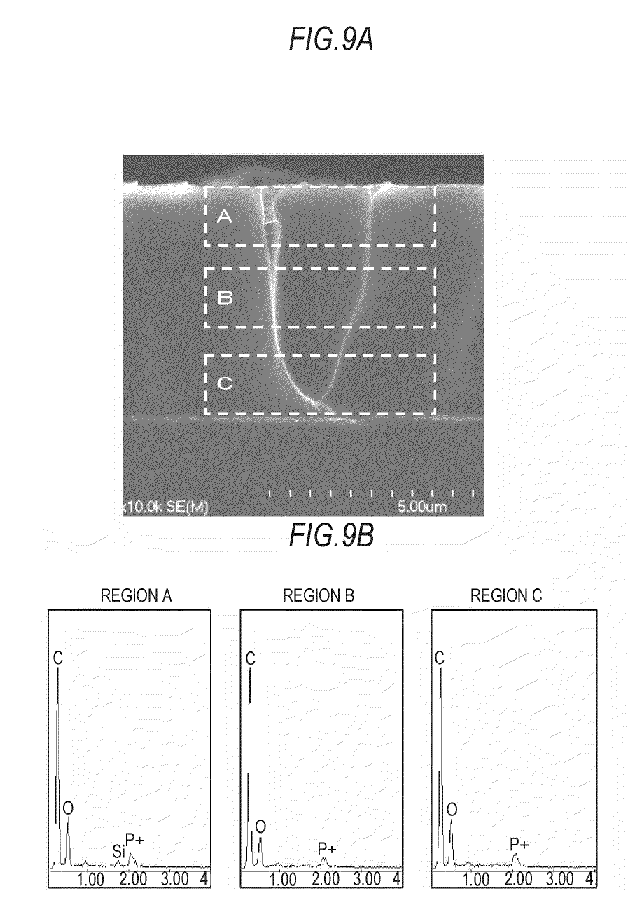

FIG. 9A is the scanning electron microscope (SEM) observed image of a cross section of the antireflective film provided with the bilayer antireflective layer obtained in Example 4-1; FIG. 9B is a graph representing the results of elemental analysis at different positions A, B, and C along the depth direction. It can be seen from FIGS. 9A and 9B that the hollow silica fine particles are localized only at the outermost surface. Specifically, the mixing of the high-refractive-index layer coating liquid and the low-refractive-index layer coating liquid is suppressed, and the layers are desirably separated, despite the fact that the bilayer antireflective layer was produced using a simultaneous coating method.

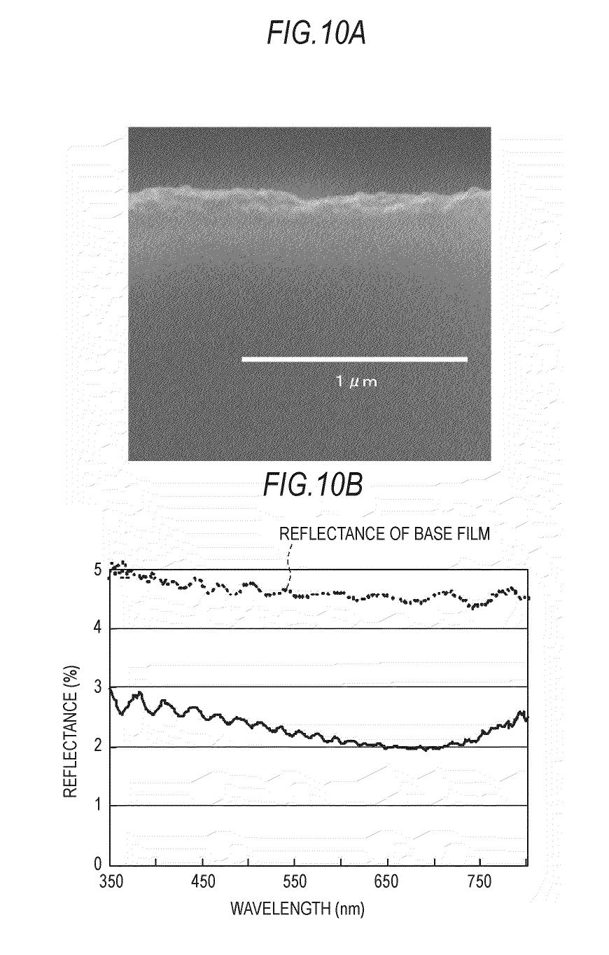

FIG. 10A is an SEM observed image of a cross section of the antireflective film obtained in Example 4-1; FIG. 10B is a graph representing reflectance. The dotted line represents the reflectance of a PET base film without the antireflective layer. As is clear from FIGS. 10A and 10B, the antireflective layer has antireflection performance. The lowest reflectance of the PET substrate provided with the antireflective layer was 2%.

### Example 4-2

In Example 4-2, the high-refractive-index layer (lower layer) and the low-refractive-index layer (upper layer) were formed using a time-lag coating method.

First, a low-refractive-index layer-forming UV-curable resin material composition coating liquid was prepared using the 10 mass % hexane sol of the OTMS•ATMS-modified hollow silica fine particles (average particle size, 60 nm) produced in Example 2-3. The contents of the respective components of the coating liquid are as follows. The mixture ratio of the components is the same as that of Example 4-1, though the total amount is different.

<Low-Refractive-Index Layer-Forming UV-Curable Resin Material Composition Coating Liquid>

1,9-Bis(acryloyloxy)nonane: 5.4 g

10 Mass % hexane sol of OTMS•ATMS-modified hollow silica fine particles: 60 g

1-Hydroxycyclohexyl phenyl ketone: 0.6 g

Hexane: 128.4 g

IPA: 45.6 g

The high-refractive-index layer-forming UV-curable resin material composition coating liquid was prepared as follows.

<High-Refractive-Index Layer-Forming UV-Curable Resin Material Composition Coating Liquid>

KAYARAD DPHA-40H: 228 g

1-Hydroxycyclohexyl phenyl ketone: 12 g

KP323 (leveling agent): 0.12 g

Methyl ethyl ketone (MEK): 160 g

The coating liquid contains a 60 mass % solid component, and the amount of solvent is suppressed at low level. The product KAYARAD DPHA-40H (Nippon Kayaku Co., Ltd.) is a commercially available product of a UV-curable multifunctional urethane acrylate oligomer.

The high-refractive-index layer (lower layer) and the low-refractive-index layer (upper layer) were laminated on the PET base film in the following order.

(1) The high-refractive-index layer-forming UV-curable resin material composition coating liquid was coated on the base film using a coater.

(2) After 20 seconds from the liquid application, the low-refractive-index layer-forming UV-curable resin material composition coating liquid was coated on the UV-curable resin material composition coating liquid using the coater.

(3) The solvent was evaporated by a heat treatment performed at 80° C. for 60 seconds in an oven, so as to form the UV-curable resin material composition layers.

(4) Each UV-curable resin material composition layer was cured by irradiation of ultraviolet rays in a purged N₂ environment at a cumulative light quantity of 300 mJ, so as to form the high-refractive-index layer (lower layer) and the low-refractive-index layer (upper layer).

The conditions of the time-lag layer coating are as follows.

Gap length between coating section and transparent base film: lower layer coating section, 40 μm; upper layer coating section, 100 μm

Running speed of transparent base film: 1 m/min

The same PET film used in Example 4-1 was used as the base film.

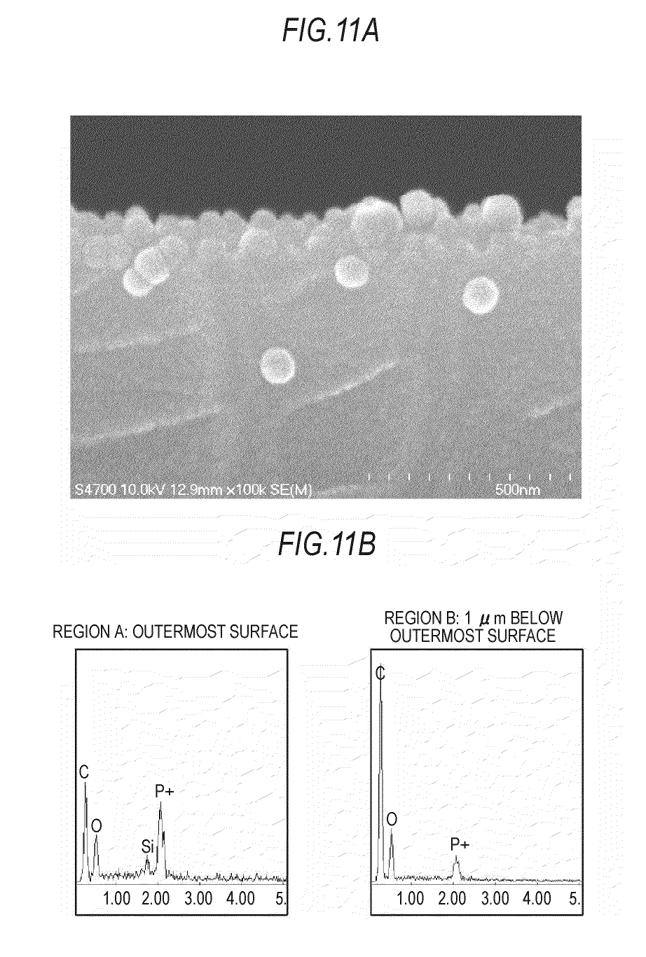

FIG. 11A is the SEM observed image of a cross section of the antireflective film provided with the bilayer antireflective layer obtained in Example 4-2; FIG. 11B is a graph representing the results of elemental analysis at different positions A, B, and C along the depth direction. It can be seen from FIGS. 11A and 11B that the hollow silica fine particles are localized only at the outermost surface. Specifically, the mixing of the high-refractive-index layer coating liquid and the low-refractive-index layer coating liquid is suppressed, and the layers are desirably separated in the bilayer antireflective layer produced by using a time-lag coating method. However, the interface between the high-refractive-index layer and the low-refractive-index layer was not clear, and the bottom levels of the hollow silica fine particles in the low-refractive-index layer were not flat. Presumably, this is the result of some mixing between the high-refractive-index layer coating liquid and the low-refractive-index layer coating liquid at the interface. This is preferable in terms of improving the adhesion between the low-refractive-index layer and the high-refractive-index layer.

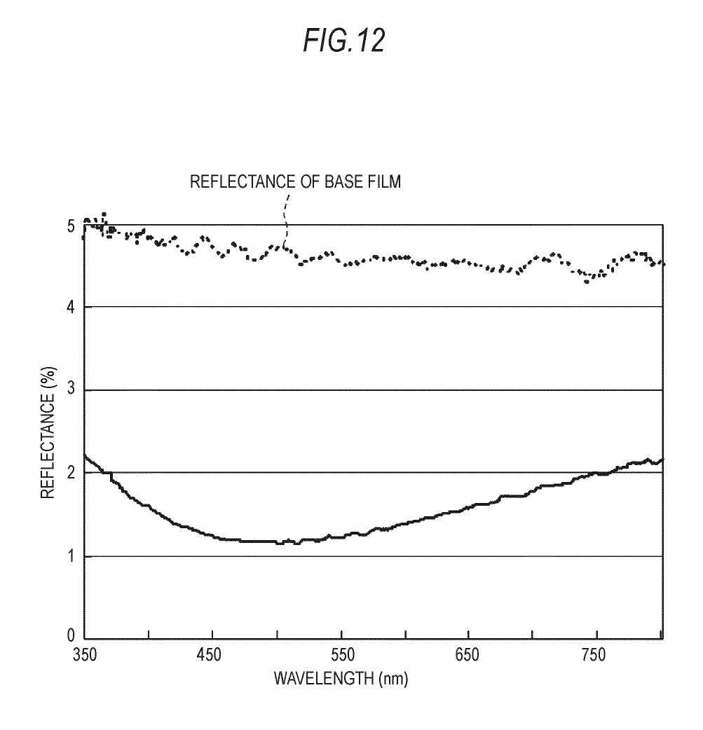

FIG. 12 is a graph representing the reflectance of the antireflective film provided with the bilayer antireflective layer obtained in Example 4-2. The dotted line represents the reflectance of a PET base film without the antireflective layer. As is clear from FIG. 12, the antireflective layer has antireflection performance. The lowest reflectance of the PET substrate provided with the antireflective layer was 1.2%. The other properties are as follows.

<Optical Properties>

Haze: 0.9%

Total light transmission: 93.8%

<Mechanical Properties>

Hardness: 2H or higher under a 750-g load in a pencil test

Abrasion resistance (measured by SW test that looks for the presence or absence of a scratch in the low-refractive-index layer after 10 strokes of a steel wool under the load of 200 g/cm²): Poor (scratched surface)

Cotton Swab Rubbing: Good

Adhesion (measured by a cross-hatch test): Good

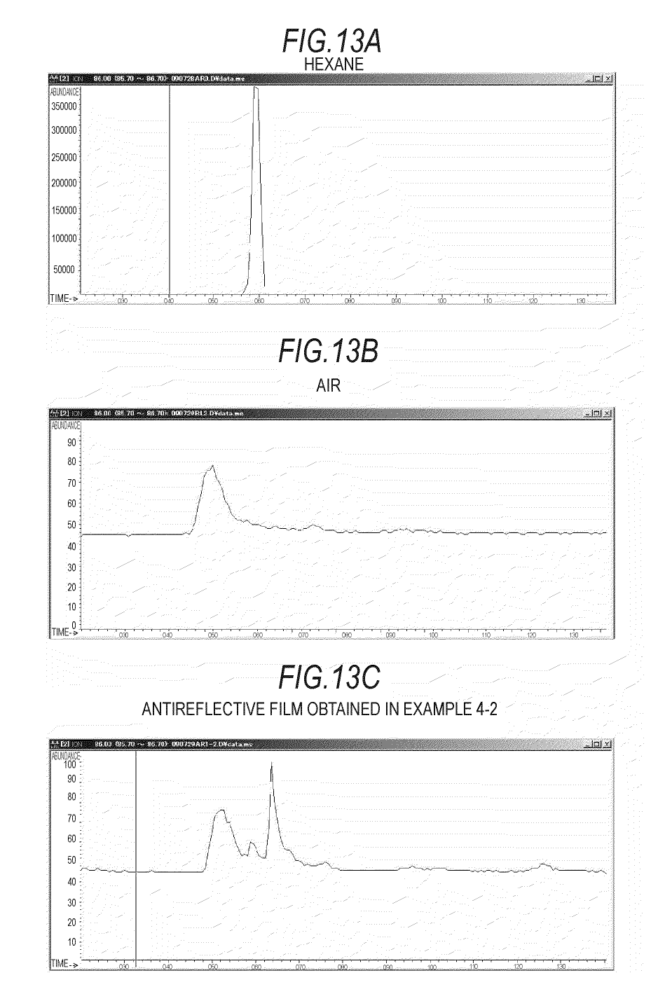

FIGS. 13A to 13C are chromatograms representing the results of the GC-MS (gas chromatography-mass spectrometry) analysis of hexane, air, and the antireflective film obtained in Example 4-2. It was found that the antireflective film contained a trace amount of hexane about 0.7 ppb.

### Example 4-3

In Example 4-3, the high-refractive-index layer (lower layer) and the low-refractive-index layer (upper layer) were formed using a sequential forming method.

The same UV-curable resin material composition coating liquids used in Example 4-2 were used for the formation of the high-refractive-index layer and the low-refractive-index layer. The same PET film used in Examples 4-1 and 4-2 was used as the base film.

The high-refractive-index layer (lower layer) and the low-refractive-index layer (upper layer) were laminated on the base film in the following order.

(1) The high-refractive-index layer-forming UV-curable resin material composition coating liquid was coated on the base film using a coater.

(2) The solvent was evaporated by a heat treatment performed at 80° C. for 60 seconds in an oven, so as to form the high-refractive-index layer-forming UV-curable resin material composition layer.

(3) The UV-curable resin material composition layer was cured by irradiation of ultraviolet rays in a purged N₂ environment at a cumulative light quantity of 300 mJ, so as to form the high-refractive-index layer.

(4) The low-refractive-index layer-forming UV-curable resin material composition coating liquid was hand-coated on the high-refractive-index layer using a bar coater.

(5) The solvent was evaporated by a heat treatment performed at 80° C. for 90 seconds in an oven, so as to form the low-refractive-index layer-forming UV-curable resin material composition layer.

(6) The UV-curable resin material composition layer was cured by irradiation of ultraviolet rays in a purged N₂ environment at a cumulative light quantity of 300 mJ, so as to form the low-refractive-index layer.

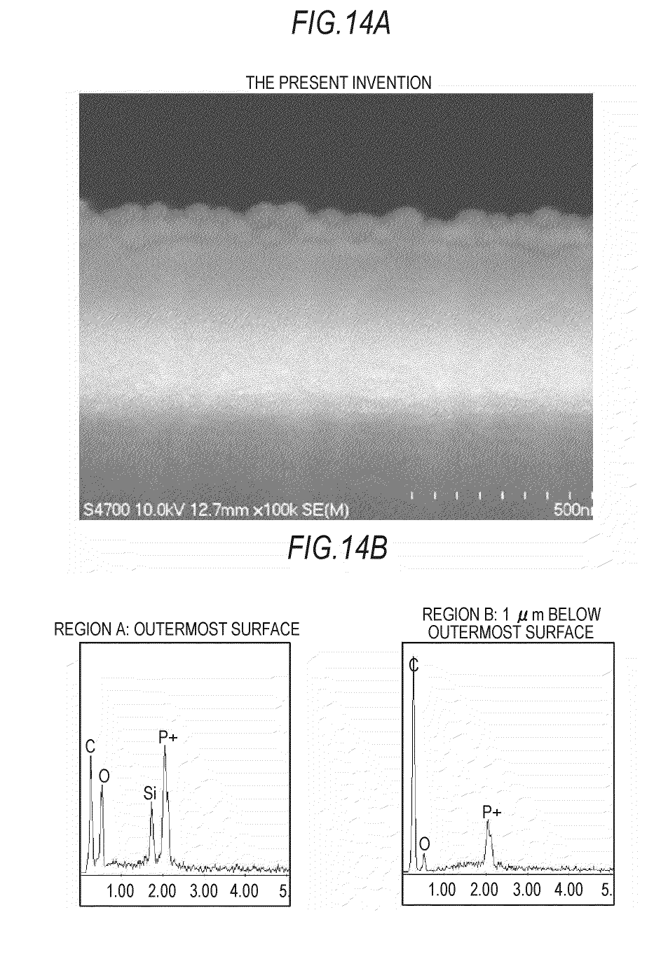

FIG. 14A is the SEM observed image of a cross section of the antireflective film provided with the bilayer antireflective layer obtained in Example 4-3; FIG. 14B is a graph representing the results of elemental analysis at different positions A, B, and C along the depth direction. It can be seen from FIGS. 14A and 14B that the hollow silica fine particles are localized only at the outermost surface. Further, a clear interface was observed between the high-refractive-index layer and the low-refractive-index layer, and the bottom levels of the hollow silica fine particles in the low-refractive-index layer were flat in the bilayer antireflective layer produced by using a sequential forming method. Specifically, the high-refractive-index layer and the low-refractive-index layer were completely independent layers, and there was no fusion at the interface. This is disadvantageous in terms of improving the adhesion between the high-refractive-index layer and the low-refractive-index layer.

The lowest reflectance of the antireflective film obtained in Example 4-3 was 1.3%, and the film had antireflection performance. The other properties are as follows.

<Optical Properties>

Haze: 1.3%

Total light transmission: 90.3%

<Mechanical Properties>

Hardness: 2H or higher under a 750-g load in a pencil test

Abrasion resistance: Poor, SW test

Cotton Swab Rubbing: Good

Adhesion: Poor, cross-hatch test

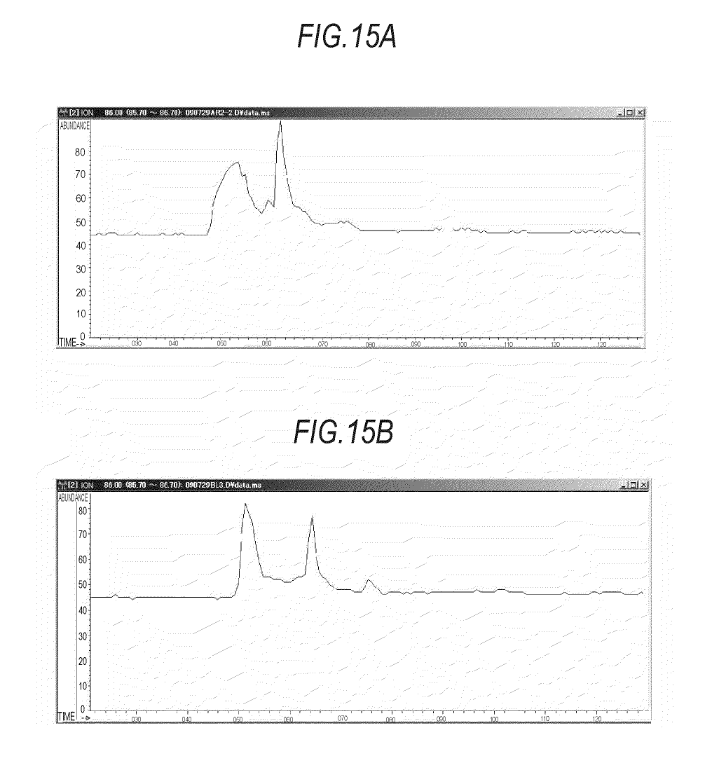

FIG. 15A is a chromatogram representing the result of the GC-MS analysis of the antireflective film. It was found that the antireflective film contained a trace amount of hexane about 1 ppb.

### Comparative Example 4-1

In Comparative Example 4-1, the high-refractive-index layer (lower layer) and the low-refractive-index layer (upper layer) were formed using a sequential forming method. The high-refractive-index layer-forming UV-curable resin material composition coating liquid and the base film are the same as those used in Example 4-3. For comparison with Example 4-3, a common coating liquid using silica fine particles and a ketone solvent was used as the low-refractive-index layer-forming UV-curable resin material composition coating liquid. The compositions of the coating liquid are as follows.

<Low-Refractive-Index Layer-Forming UV-Curable Resin Material Composition Coating Liquid>

1,9-Bis(acryloyloxy)nonane: 5.4 g

20 Mass % IPA sol of vinyl-modified hollow silica fine particles (average particle size, 50 nm): 30 g

1-Hydroxycyclohexyl phenyl ketone: 0.6 g

Methyl isobutyl ketone (solvent): 204 g

The coating liquid contained a 5 mass % solid component. The content of the modified silica fine particles in the solid component was 50 mass %. The product Surulia 06SN (Nikki Shokubai Kasei) was used as the 20 mass % IPA sol of vinyl-modified hollow silica fine particles.

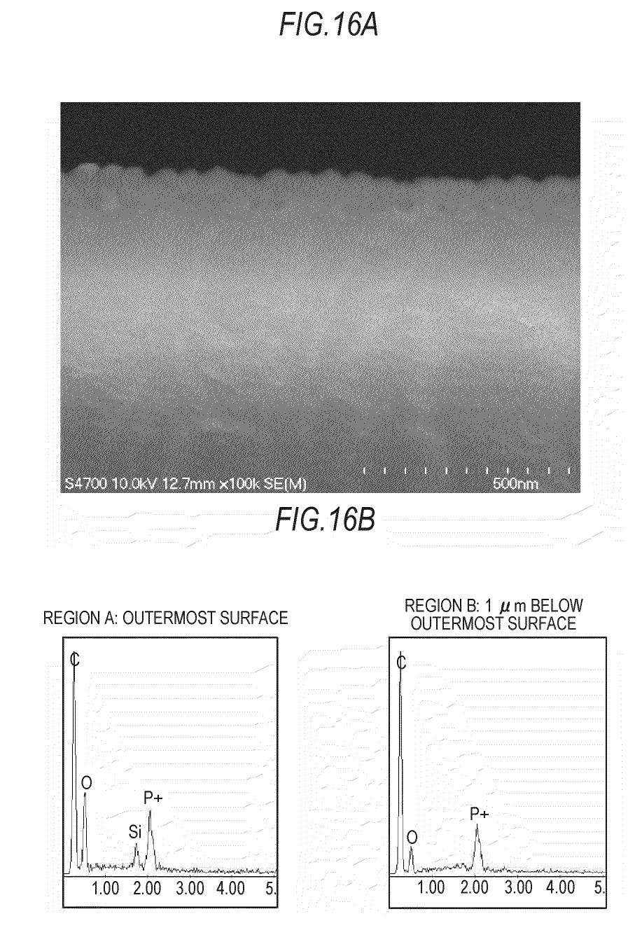

The antireflective film was produced according to the procedure of Example 4-3. FIG. 16A is the SEM observed image of a cross section of the antireflective film provided with the bilayer antireflective layer obtained in Comparative Example 4-1; FIG. 16B is a graph representing the results of elemental analysis at different positions A, B, and C along the depth direction. It can be seen from FIGS. 16A and 16B that the hollow silica fine particles are localized only at the outermost surface. Further, because the bilayer antireflective layer was formed using a sequential forming method as in Example 4-3, a clear interface was observed between the high-refractive-index layer and the low-refractive-index layer, and the bottom levels of the hollow silica fine particles in the low-refractive-index layer were flat. Specifically, the high-refractive-index layer and the low-refractive-index layer were completely independent layers. This is disadvantageous in terms of improving the adhesion between the high-refractive-index layer and the low-refractive-index layer.

The properties of the antireflective film obtained in Comparative Example 4-1 are as follows.

<Mechanical Properties>

Hardness: Less than 2H under a 750-g load in a pencil test

Abrasion resistance: Poor, SW test

Cotton swab rubbing: Good

Adhesion: Poor, cross-hatch test

Initial adhesion: Poor, grid test

FIG. 15B is a chromatogram representing the result of the GC-MS analysis of the antireflective film. Hexane was not detected.

Table 4 presents the coating methods, and the properties of the antireflective films of Examples 4-1 to 4-3 and Comparative Example 4-1.

TABLE 4

| | | | | | | Comparative |
|---|---|---|---|---|---|---|
| | | | Example 4-1 | Example 4-2 | Example 4-3 | Example 4-1 |
| Method of formation | | | Simultaneous | Time-lag | Sequential | Sequential |
| | | | coating | coating | | |
| Properties | Optical | Lowest reflectance | 2 | 1.2 | 1.3 | — |
| | properties (%) | Haze | — | 0.9 | 1.3 | — |
| | | Total light | — | 93.8 | 90.3 | — |
| | | transmission | | | | |

| | | | | | |
|---|---|---|---|---|---|
| | Hardness: Pencil test | — | 2H or higher | 2H or higher | Below 2H |
| | Abrasion resistance: | — | Less than | Less than | Less than |
| | SW test (10 strokes) | | 200 g | 200 g | 200 g |
| | Adhesion: Cross-hatch test | — | Good | Poor | Poor |
| Film analysis | Layer separation | Good | Good | Good | Good |
| | Post deposition residual hexane | — | Present | Present | Absent |

The antireflective film can be suitably used for various displays, including liquid crystal televisions, organic EL televisions, personal computers, and portable gaming machines. The UV-curable resin material composition of an embodiment can be suitably used to form an antireflective layer on a surface of plastic molded products or coated objects.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A UV-curable resin material composition coating liquid comprising:
a UV-curable resin material composition dissolved or dispersed in a nonpolar solvent or a substantially nonpolar mixed solvent; the UV-curable resin material composition including a monomer and/or an oligomer thereof that have two or more (meth)acryloyl groups, and affinity to a nonpolar solvent;
modified hollow silica fine particles altered to have affinity to a nonpolar solvent by introduction of an aliphatic hydrocarbon group to surfaces of hollow silica fine particles; and
a polymerization initiator.

2. The UV-curable resin material composition coating liquid of claim 1, wherein the nonpolar solvent is an aliphatic hydrocarbon solvent and/or an alicylic hydrocarbon solvent.

3. The UV-curable resin material composition coating liquid of claim 1, wherein the aliphatic hydrocarbon group has a C═C bond, and/or a polymerizable group polymerizable with the monomer and/or the oligomer thereof is introduced to the surfaces of the modified hollow silica fine particles in addition to the aliphatic hydrocarbon group.

4. The UV-curable resin material composition coating liquid of claim 3, wherein the polymerizable group is a (meth)acryloyl group or a vinyl group.

5. The UV-curable resin material composition coating liquid of claim 1, wherein the aliphatic hydrocarbon group and/or the polymerizable group are introduced as organic groups of a silane coupling agent residue.

6. The UV-curable resin material composition coating liquid of claim 1, wherein the UV-curable resin material composition includes the monomer and/or the oligomer thereof in a content of 70 to 30 mass %, the modified hollow silica fine particles in a content of 30 to 70 mass %, and the polymerization initiator in a content of 0.1 to 10.0 mass %.

7. An antireflective film comprising:
a low-refractive-index layer provided on an outermost surface of a base film either directly on the base film or via a functional layer,
the low-refractive-index layer
being formed using a UV-curable resin material composition coating liquid including a UV-curable resin material composition dissolved or dispersed in a nonpolar solvent or a substantially nonpolar mixed solvent, and
being a cured layer of a resin material composition layer that includes the monomer and/or the oligomer thereof that have two or more (meth)acryloyl groups, and affinity to a nonpolar solvent;
the modified hollow silica fine particles altered to have affinity to a nonpolar solvent by introduction of an aliphatic hydrocarbon group to surfaces of hollow silica fine particles; and
the polymerization initiator.

8. The antireflective film of claim 7, wherein the low-refractive-index layer is provided in direct contact with the surface of the base film that has no affinity to a nonpolar solvent.

9. The antireflective film of claim 7, wherein the low-refractive-index layer is provided in contact with a high-refractive-index layer provided as the functional layer having a higher refractive index than the base film.

10. A method for producing an antireflective film comprising:
preparing a low-refractive-index layer coating liquid that contains a UV-curable resin material composition that forms a low-refractive-index layer having a lower refractive index than a base film, the low-refractive-index layer coating liquid being prepared by dissolving or dispersing in a nonpolar solvent or a substantially nonpolar mixed solvent a UV-curable resin material composition that includes a monomer and/or an oligomer thereof that have two or more (meth)acryloyl groups, and affinity to a nonpolar solvent,
modified hollow silica fine particles altered to have affinity to a non-polar solvent by introduction of an aliphatic hydrocarbon group on surfaces of hollow silica fine particles,
and a polymerization initiator;
layering the low-refractive-index layer coating liquid on the base film either directly or via a functional layer;
evaporating the nonpolar solvent or the substantially nonpolar mixed solvent from the layer of the low-refractive-index layer coating liquid; and
curing the UV-curable resin material composition layer to form the low-refractive-index layer on an outermost surface of the base film.

11. The method of claim 10,
wherein a high-refractive-index layer having a higher refractive index than the base film is formed as the functional layer by:
preparing a high-refractive-index layer coating liquid that contains a UV-curable resin material composition that forms the high-refractive-index layer;
layering the high-refractive-index layer coating liquid on the base film; and
curing the resin material composition layer that forms the high-refractive-index layer, and
wherein the low-refractive-index layer is formed in contact with the high-refractive-index layer.

12. The method of claim 11, further comprising:
forming the high-refractive-index layer coating liquid using a polar solvent;
simultaneously layering the high-refractive-index layer coating liquid and the low-refractive-index layer coating liquid on the base film;
evaporating the solvents from the high-refractive-index layer coating liquid layer and the low-refractive-index layer coating liquid layer; and
simultaneously curing the resin material composition layer that forms the high-refractive-index layer, and the resin material composition layer that forms the low-refractive-index layer.

13. The method of claim 11, further comprising:
forming the high-refractive-index layer coating liquid without using a solvent;
simultaneously layering the high-refractive-index layer coating liquid and the low-refractive-index layer coating liquid on the base film;
evaporating the nonpolar solvent or the substantially nonpolar mixed solvent from the low-refractive-index layer coating liquid layer; and
simultaneously curing the resin material composition layer that forms the high-refractive-index layer, and the resin material composition layer that forms the low-refractive-index layer.

14. The method of claim 11, further comprising:
forming the high-refractive-index layer coating liquid using a polar solvent;
layering the high-refractive-index layer coating liquid on the base film;
layering the low-refractive-index layer coating liquid on the high-refractive-index layer coating layer after at least a part of the polar solvent is evaporated from the high-refractive-index layer coating layer during a time lag following the layering of the high-refractive-index layer coating layer;
evaporating the solvents from the high-refractive-index layer coating liquid layer and the low-refractive-index layer coating liquid layer; and
simultaneously curing the resin material composition layer that forms the high-refractive-index layer, and the resin material composition layer that forms the low-refractive-index layer.
